(19) United States
(12) Patent Application Publication
(10) Pub. No.: US 2008/0155387 A1
(43) Pub. Date: Jun. 26, 2008

(54) INFORMATION PROCESSING APPARATUS, CONTROL METHOD THEREOF, AND PROGRAM

(75) Inventor: Kenta Yabe, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/962,788

(22) Filed: Dec. 21, 2007

(30) Foreign Application Priority Data
Dec. 22, 2006 (JP) 2006-346654

(51) Int. Cl. G06F 3/14

(52) U.S. Cl. 715/204

(57) ABSTRACT

Template layout processing is executed by inserted a template into a flow area set in a document. The size of the template when data is inserted into the field area in the template inserted in the flow area is required. It is determined wheterh or not the template can be arranged in the flow area by using the size of the template and size of an empty area of the flow area. When said determination step determined that the template cannot be arranged in the flow area, a positional relation of the template is redefined.

### BACKGROUND OF THE INVENTION

1. Field of the Invention

The present invention relates to an information processing apparatus which lays out, in a document, a template prepared by arranging a field area for inserting data of a data field selected from a record including a plurality of types of data fields, a control method thereof, and a program.

2. Description of the Related Art

As various kinds of merchandise are produced, shortening of the merchandise life has recently received attention. The necessity for CRM (Customer Relationship Management) and one-to-one marketing has also received a great deal of attention due to factors such as customer's orientation to customized services with the prevalence of the Internet. These methods try to raise the customer satisfaction, win new customers, and reatin existing customers.

One-to-one marketing is a kind of database marketing. According to this technique, a database of individual attribute information including the age, sex, hobby, preference, and purchase log of a customer is created, and the contents of the database are analyzed to make a proposal complying with customer's needs. A typical method of this marketing is variable printing. These days, a variable printing system which customizes a document for each customer and outputs the document has been developed along with the development of the DTP (Desk Top Publishing) technique and the pervasion of digital printing apparatuses. The variable printing system needs to create a customized document in which contents of different amounts for respective customers are optimally laid out.

Generally when creating such a customized document by the variable printing system, containers are laid out in a document. The container is a drawing area for drawing contents (drawing contents such as an image and text), and is also called a field area.

Containers are laid out in a document, and a database is associated with the layout (various contents in the database are associated with the containers). As a result, a desired customized document (called a document template) can be created. The contents of the containers can be changed (made variable) by properly switching them in the customized document (by changing the association). Such a document is called a variable data document, and a printing system using the variable data document is a variable printing system.

In a conventional variable printing system, the size of a container associated with a text or image serving as contents is fixed. When contents in the database are inserted (flowed) into a container and the data amount is larger than the container size, the following problems arise. That is, if the data is a text, overlapping of the text occurs. If the data is an image, clipping of the image occurs. When the data amount is smaller than the container size, no proper display may be obtained such that a gap appears between the container and its contents.

As another technique of changing the layout in order to solve these problems, a “Layout Design Apparatus” in Japanese Patent Laid-Open No. 7-129658 discloses a technique of, when the size of a given container becomes large, decreasing the size of another container adjacent to the given container.

In the conventional variable printing system, a multidata technique of laying out a plurality of data in one document is also known in addition to a technique of laying out one data of a database in one document.

This technique allows changing the number of layout data for each customer, and creating a document customized in more detail for each customer.

As yet another technique, an element “layout area” is further introduced into the “Layout Design Apparatus”. More specifically, a subtemplate which defines a basic shape is inserted (flowed) into the layout area to insert (flow) a plurality of similar items into a predetermined area of a page.

For example, a “Layout Adjustment Method, Apparatus, and Program” in Japanese Patent Laid-Open No. 2006-074226 discloses an arrangement for preferably setting the size and layout of a subtemplate in accordance with the size of contents pasted in the subtemplate. This arrangement can reflect the intention of a user who lays out contents.

“Contents” generically mean electronic data such as image data and text data which are arranged and inserted in a layout when creating a document in the variable printing system.

A “container” means a layout frame within which contents are arranged and inserted when creating a document layout in the variable printing system.

A “subtemplate” means a small-size template structure defined in advance on the assumption that the subtemplate is arranged in a layout when creating a document layout in the variable printing system.

A kind of variable printing system can dynamically change the container size in accordance with the size of contents to be inserted, in order to properly lay out contents of different sizes in a document. This variable printing system has a function of defining the layout of each product (for the product name, product image, and product description) as a subtemplate in advance when creating the layout of a document such as a product catalog.

The variable printing system can set, in a document, an area (to be referred to as a flow area hereinafter) capable of flowing a subtemplate. That is, the flow area is defined in a document template, and allows laying out a subtemplate. By flowing a subtemplate corresponding to the type of data in a database into a flow area, a plurality of data can be automatically arranged in a corresponding layout in one document.

The subtemplate size changes in accordance with corresponding data, i.e., contents to be inserted while the layout structure is maintained.

If the size of a subtemplate exceeds that of a flow area where the subtemplate is to be laid out, wraparound of the contents of each subtemplate occurs in the flow area (the contents move to a free space in the flow area).

More specifically, for example, according to Japanese Patent Laid-Open No. 2006-074226, subtemplates are laid out in a flow area in accordance with an arrangement order set for the flow area. For example, when the arrangement order is Z arrangement from the upper left to lower right (arrangement along the vertical direction), subtemplates are sequentially arranged in the row direction (horizontal direction). If the arrangement space runs out, it moves in the column direction (vertical direction) to the next row.

However, when subtemplates are arranged in the flow area in this manner, an unwanted space may be generated in the flow area depending on the subtemplate size, impairing the appearance.

As a result of flowing subtemplates of different sizes into a flow area, a layout result hardly reflecting the user intention is generated.

As another example, if only subtemplates less than the number of subtemplates the user wants can be flowed into a flow area set in a document of one page, subtemplates which cannot be flowed are flowed into a document of another page. This may increase the total number of output document pages.

If subtemplates more than the number of subtemplates the user wants are flowed into a flow area set in a document of one page, a redundant space may be generated in the page.

As described above, the subtemplate size changes in accordance with contents while the layout structure of the subtemplate is maintained. The variable printing system may produce a layout result the user does not want.

### SUMMARY OF THE INVENTION

The present invention has been made to overcome the conventional drawbacks, and has as its object to provide an information processing apparatus capable of controlling a document layout which sufficiently reflects the user intention, a control method thereof, and a computer program.

According to the first aspect of the present invention, an information processing apparatus which lays out, in a document, a template prepared by arranging a field area for inserting data of a data field selected from a record including a plurality of types of data fields, the apparatus comprises layout means for executing layout processing for the template by inserting the template into a flow area set in the document; acquisition means for acquiring a size of the template when data is inserted into the field area in the template inserted in the flow area; first determination means for determining whether or not the template can be arranged in the flow area by using the size of the template and size of an empty area of the flow area; and definition means for redefining a positional relation of the template when the first determination means determined that the template cannot be arranged in the flow area.

In a preferred embodiment, the definition means changes, in the template, position of the data field which cannot be arranged in the flow area.

In a preferred embodiment, the apparatus further comprises deformation means for deforming a shape of the template to make the shape of the template conform to a shape of the flow area after changing the positional relation of the field area by the definition means.

In a preferred embodiment, the apparatus further comprises setting means for making a setting for redefinition of the template.

In a preferred embodiment, the setting means has a first setting item for setting whether to permit/inhibit redefinition of the template, and a second setting item for setting a margin of a field area to be rearranged when the redefinition is permitted.

In a preferred embodiment, the definition means comprises second determination means for determining, based on setting information of the setting means, whether to redefine the template, discrimination means for discriminating a field area whose arrangement is to be redefined, on the basis of a size of a field area after inserting data into the field area, in order to change the positional relation of the field area arranged in the template when the second determination means determines to redefine the positional relation of the template, and change means for changing the layout structure of the field area arranged in the template by changing the arrangement of the field area to be redefined that is discriminated by the discrimination means.

In a preferred embodiment, when a link for linking a second field area to a first field area discriminated to be redefined is set, the discrimination means discriminates even the second field area as a field area to be redefined.

In a preferred embodiment, the apparatus further comprises link setting means for setting whether to permit/inhibit cancellation of the link when the definition means redefines the template.

In a preferred embodiment, the apparatus further comprises designation means for, when the second determination means determines not to redefine the template, designating an arrangement rule to change a layout structure of the field area arranged in the template without redefining the template.

According to the second aspect of the present invention, the method of controlling an information processing apparatus which lays out, in a document, a template prepared by arranging a field area for inserting data of a data field selected from a record including a plurality of types of data fields, the method comprises a layout step of causing layout means to execute layout processing for the template by inserting the template into a flow area set in the document; an acquisition step of causing acquisition means to acquire a size of the template when data is inserted into the field area in the template inserted in the flow area; a determination step of causing determination means to determine whether or not the template can be arranged in the flow area by using the size of the template and size of an empty area of the flow area, and a definition step of causing definition means to redefine a positional relation of the template when the determination step determined that the template cannot be arranged in the flow area.

According to the third aspect of the present invention, a computer program which is stored in a computer-readable medium and causes a computer to execute control of an information processing apparatus that lays out, in a document, a template prepared by arranging a field area for inserting data of a data field selected from a record including a plurality of types of data fields, the program causes the computer to execute a layout step of executing layout processing for the template by inserting the template into a flow area set in the document, an acquisition step of acquiring a size of the template when data is inserted into the field area in the template inserted in the flow area, a determination step of causing determination means to determine whether or not the template can be arranged in the flow area by using the size of the template and size of an empty area of the flow area, and a definition step of causing definition means to redefine a positional relation of the template when the determination step determined that the template cannot be arranged in the flow area.

Further features of the present invention will be apparent from the following description of exemplary embodiments with reference to the attached drawings.

### BRIEF DESCRIPTION OF THE DRAWINGS

FIG. 1A is a block diagram showing a configuration of an information processing system according to the first embodiment of the present invention;

FIG. 1B is a block diagram showing the hardware configuration of a host computer as a building element of the information processing system according to the first embodiment of the present invention;

FIG. 1C is a block diagram showing another configuration of the information processing system according to the first embodiment of the present invention;

FIG. 2 is a view for explaining an outline of variable data printing according to the first embodiment of the present invention;

FIG. 3 is a view showing an example of a user interface according to the first embodiment of the present invention;

FIG. 4 is a view showing a display of a container in the user interface according to the first embodiment of the present invention;

FIGS. 5A to 5D are views for explaining container display rules according to the first embodiment of the present invention;

FIG. 6 is a flowchart showing link setting processing according to the first embodiment of the present invention;

FIGS. 7A to 7C are views showing transitions of a user interface when setting a link according to the first embodiment of the present invention;

FIG. 8 is a flowchart showing layout calculation processing according to the first embodiment of the present invention;

FIG. 9 is a flowchart showing details of the layout calculation processing according to the first embodiment of the present invention;

FIG. 10 is a view for explaining a set of containers in the layout calculation processing according to the first embodiment of the present invention;

FIGS. 11A to 11C are views showing an example of a user interface in the layout calculation processing according to the first embodiment of the present invention;

FIG. 12 is a view showing an example of a user interface for setting a variable link according to the first embodiment of the present invention;

FIG. 13 is a view showing an example of a user interface for implementing a link setting function according to the first embodiment of the present invention;

FIG. 14 is a flowchart showing variable link setting processing according to the first embodiment of the present invention;

FIG. 15 is a view showing a layout result when a fixed-size link is used according to the first embodiment of the present invention;

FIG. 16 is a view showing a layout result when a variable-size link is used according to the first embodiment of the present invention;

FIG. 17A is a view for explaining a multirecord function according to the first embodiment of the present invention;

FIG. 17B is a flowchart showing subtemplate layout processing according to the first embodiment of the present invention;

FIG. 18 is a view showing an example of a subtemplate set in the flow area of a document template according to the first embodiment of the present invention;

FIG. 19 is a view showing an arrangement of inserting variable data into the subtemplate in FIG. 18 and arranging the subtemplate in the flow area of a document template according to the first embodiment of the present invention;

FIG. 20 is a view showing a state in which no subtemplate can be arranged in a flow area according to the first embodiment of the present invention;

FIG. 21 is a flowchart showing redefinition processing for the layout structure of a subtemplate according to the first embodiment of the present invention;

FIG. 22 is a view for explaining the process of rearranging a container according to the first embodiment of the present invention;

FIG. 23 is a view showing the layout structure of a redefined subtemplate according to the first embodiment of the present invention;

FIG. 24 is a view for explaining wraparound processing for a subtemplate in a flow area according to the first embodiment of the present invention;

FIG. 25 is a view for explaining a concrete case where the layout structure of a subtemplate cannot be redefined (redefinition fails) according to the first embodiment of the present invention;

FIG. 26 is a view showing an example of a user interface for setting flowing of a container according to the first embodiment of the present invention;

FIG. 27 is a view showing an example of flowing a container into a subtemplate according to the first embodiment of the present invention;

FIG. 28 is a view showing an example of a user interface for setting redefinition of the layout structure of a subtemplate, and setting a margin when arranging a container according to the first embodiment of the present invention;

FIG. 29 is a view showing an example of a user interface for making a link setting according to the second embodiment of the present invention;

FIG. 30 is a view showing an arrangement of a subtemplate according to the second embodiment of the present invention;

FIG. 31 is a view showing a redefined arrangement of a subtemplate when the configuration of the first embodiment is used before a description of the configuration of the second embodiment of the present invention;

FIG. 32 is a flowchart showing redefinition processing for the layout structure of a subtemplate according to the second embodiment of the present invention; and

FIG. 33 is a view showing a redefined arrangement of a subtemplate according to the second embodiment of the present invention.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

<System Configuration>

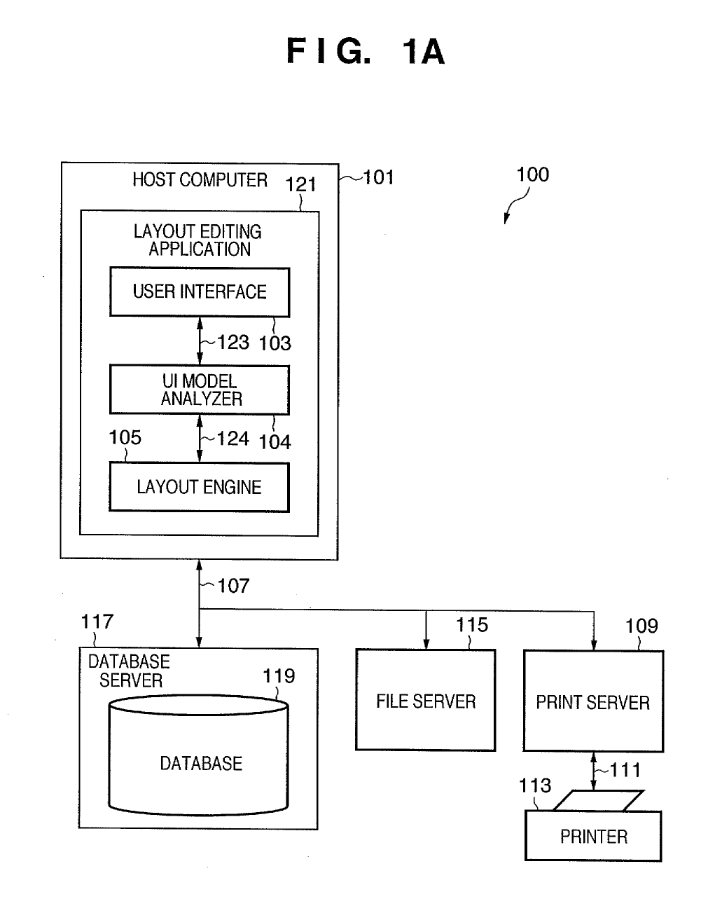

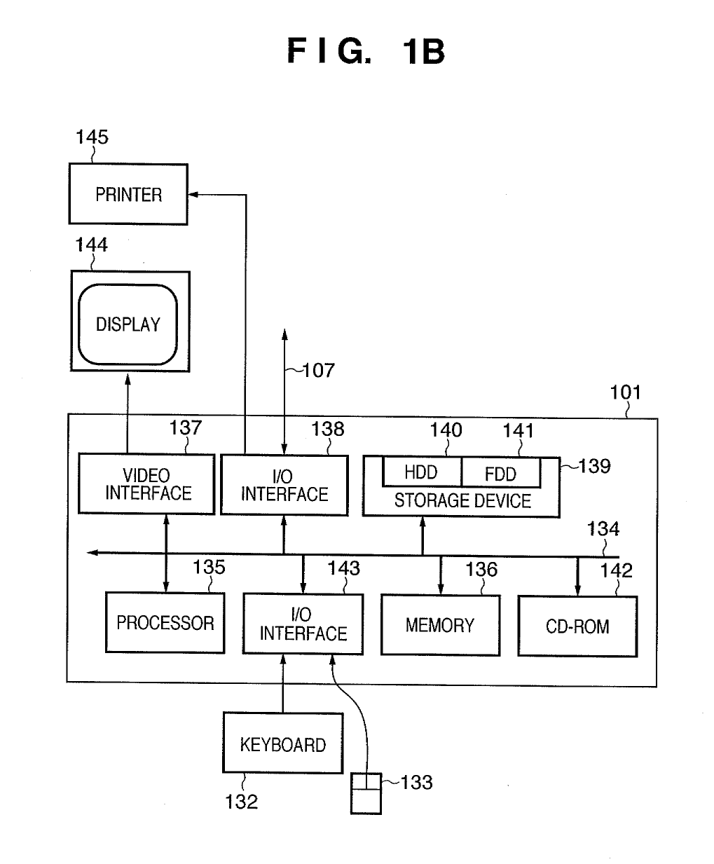

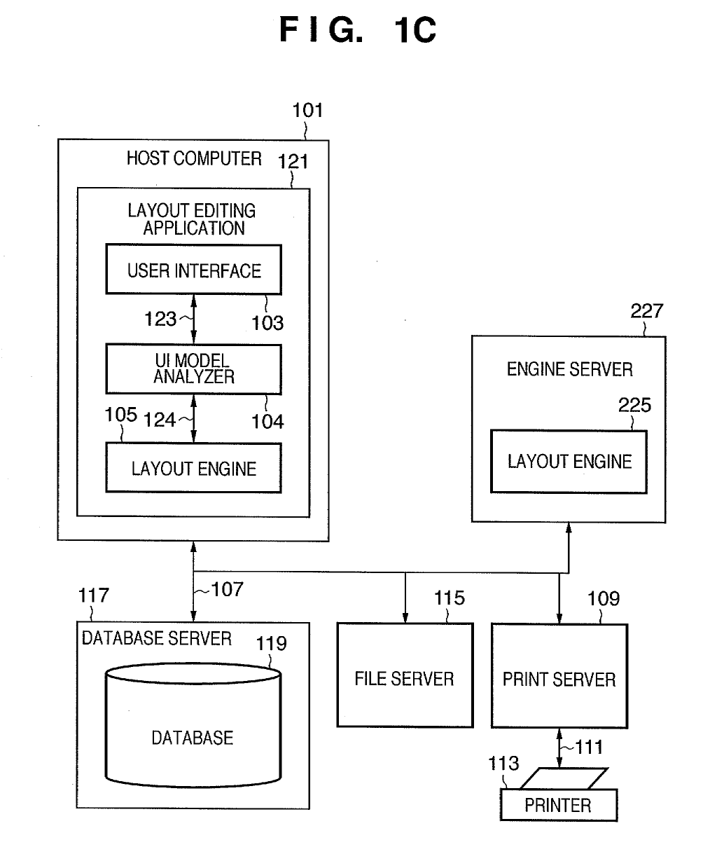

The hardware configuration of an information processing system and that of a host computer as a building element of the information processing system according to the first embodiment will be described with reference to FIGS. 1A and 1B. FIG. 1A is a block diagram showing a configuration of the information processing system according to the first embodiment of the present invention. FIG. 1B is a block diagram showing the hardware configuration of the host computer as a building element of the information processing system according to the first embodiment of the present invention.

Various computers (e.g., a database server 117, file server 115, and print server 109) other than the host computer in FIG. 1A also have the same hardware configuration as, e.g., that in FIG. 1B.

In FIG. 1A, an information processing system 100 is built by connecting a host computer 101 serving as the information processing apparatus of the present invention, the database server 117, the file server 115, and the print server 109 to each other via a network 107.

The database server 117 comprises a database 119. The print server 109 is connected to a printer 113. The print server 109 can properly output print data received via the network 107 to the printer 113, and cause the printer 113 to print the print data.

The information processing system 100 in FIG. 1A especially shows a configuration of a variable printing system which prints a variable data document. Variable printing processing to be described in the first embodiment is executed by the host computer 101 (formed from a general-purpose computer module) functioning as a layout editing apparatus.

The host computer 101 executes all or part of a layout editing application 121 which can run in the variable printing system 100. In particular, software executed by the host computer 101 performs processing associated with layout editing and processing associated with printing of a variable data document.

Software and computer programs such as the layout editing application 121 are stored in a computer-readable medium, loaded from it into a memory 136 of the host computer 101, and executed. The computer-readable medium which stores software and computer programs is a computer program product. The computer program product used in, e.g., the host computer 101 provides an apparatus suitable for layout editing and variable printing of a variable data document.

As shown in FIG. 1B, a keyboard 132 and a mouse 133 serving as a pointing device are connected as input devices to the host computer 101 via an I/O (Input/Output) interface 143. A display device 144 is connected as an output device to the host computer 101 via a video interface 137. A printer 145 can also be connected to the host computer 101 via an I/O interface 138.

The I/O interface 138 also has a function of connecting the host computer 101 to the network 107. The I/O interface 138 can connect the host computer 101 via the network 107 to another computer apparatus (external device) in the variable printing system 100. Typical examples of the network 107 are a local area network (LAN) and wide area network (WAN).

As shown in FIG. 1B, the host computer 101 includes at least one processor 135, and a memory 136 which is formed from a semiconductor memory such as a random access memory (RAM) or read only memory (RON). A storage device 139 includes a hard disk drive (HDD) 140 capable of exchanging data with a computer readable medium which stores various data such as a program, and a floppy® disk drive (FDD) 141.

Although not shown in FIG. 1B, various storage devices such as a magnetic tape drive and memory card are also available as the storage device 139. A CD-ROM drive 142 is provided as a nonvolatile data source (a CD-ROM may also provide a computer program).

The host computer 101 communicates with the building elements 135 to 143 of the host computer 101 via an interconnection bus 134. This communication is done by an operating system such as GNU/LINUX or Microsoft Windows®, or typically according to an operating system. Alternatively, this communication is done by a method in a conventional operation mode of a computer system which is formed by a well-known related technique. That is, the building elements 135 to 143 are connected via the interconnection bus 134 so that they can communicate with each other, and are used by an operating system installed in the host computer 101.

Conceivable examples of the host computer 101 shown in FIG. 1B are an IBM-compatible PC (Personal Computer), Sparcstation available from Sun, and a computer system including them.

<Outline of Layout Editing Application>

In the first embodiment, the layout editing application 121 is resident in the hard disk drive 140, and the processor 135 controls execution and loading of the layout editing application 121. Data fetched from the intermediary storage device of the layout editing application 121 and the network 107 uses the memory 136 in correspondence with the hard disk drive 140.

For example, an encoded program of the layout editing application 121 is stored in a CD-ROM or floppy® disk. This program is loaded via the corresponding CD-ROM drive 142 or floppy® disk drive 141, and installed in the hard disk drive 140.

As another example, the layout editing application 121 may also be loaded from the network 107 into the host computer 101, and installed in the hard disk drive 140.

Various software programs including the layout editing application 121 may also be loaded into the host computer 101 from a magnetic tape, ROM, integrated circuit, or magneto-optical disk. These software programs may also be loaded into the host computer 101 by radio communication (e.g., infrared communication) between the host computer 101 and another device. These software programs may also be loaded into the host computer 101 from a computer-readable card (e.g., a PCMCIA card), or another proper computer including e-mail communication, an intranet, or the Internet having recording information on a WEB site. They are merely examples of the computer-readable medium, and it is apparent that another computer-readable medium is also available.

In FIG. 1A, the layout editing application 121 causes the host computer 101 to perform variable printing (to be also referred to as variable data printing (VDP)). The layout editing application 121 includes two software components: a layout engine 105 and user interface 103.

The layout engine 105 is a software component which loads records one by one from variable data stored for each record in the database 119, under constraints on the size and position of a container (rectangular range) serving as a drawing area (partial area). Based on the loaded variable data and the container constraints, the layout engine 105 calculates a layout including the size and position of a container to which the loaded variable data is flowed.

Further, the layout engine 105 also performs processing of drawing variable data assigned to a container and generating an image of a variable data document. However, the present invention is not limited to this, and the layout engine 105 operates as an application which determines the size and position of each partial area (container) and outputs drawing information to a printer driver (not shown) The printer driver may perform variable data document image drawing processing and generate print data.

The user interface 103 allows the user to set the layout and attribute of a container, and prompts him to create a document template. The user interface 103 provides a mechanism of associating each container in the document template with a data source (variable data (contents) in the database 119).

A UI model analyzer 104 converts a user interface element such as a container, anchor, slider, or link provided by the user interface 103 into an internal format that can be recognized by the layout engine 105. The UI model analyzer 104 can easily replace the user interface 103 with a user interface of another display/input format without changing the layout engine 105.

The user interface 103 and UI model analyzer 104 communicate with each other via a communication channel 123. The UI model analyzer 104 and layout engine 105 communicate with each other via a communication channel 124.

A data source for generating a variable data document is the typical database 119 in the database server 117 which generally executes a database application and is formed from another computer.

The host computer 101 communicates with the database server 117 via the network 107. The layout editing application 121 generates a document template to be saved in the host computer 101 or the file server 115 generally formed from another computer.

The layout editing application 121 generates a variable data document formed from a document template merged with variable data (content data) serving as contents flowed into a container. Variable data documents are saved in the local file system of the host computer 101 or the file server 115, or directly by the printer 113 via the print server 109.

The print server 109 is a computer which provides a network function to the printer 113 not directly connected to the network 107. The print server 109 and printer 113 are connected via a typical communication channel 111 (e.g., USB, IEEE1394, or wireless LAN).

Another configuration of the variable printing system 100 will be described with reference to FIG. 1C.

FIG. 1C is a block diagram showing another configuration of the information processing system according to the first embodiment of the present invention.

FIG. 1C shows a configuration in which an engine server 227 is added to the network 107 and a layout engine 225 is installed in the engine server 227. That is, the layout engine 105 in the host computer 101 is implemented in the engine server 227. This configuration can reduce the processing load of the host computer 101.

The engine server 227 is formed from a typical computer, similar to the remaining servers. A document template saved in the file server 115 can be combined with data saved in the database 119 in order to generate a document by the layout engine 225 for printing or another purpose. The user requests this operation via the user interface 103 or requests it to print only a specific record.

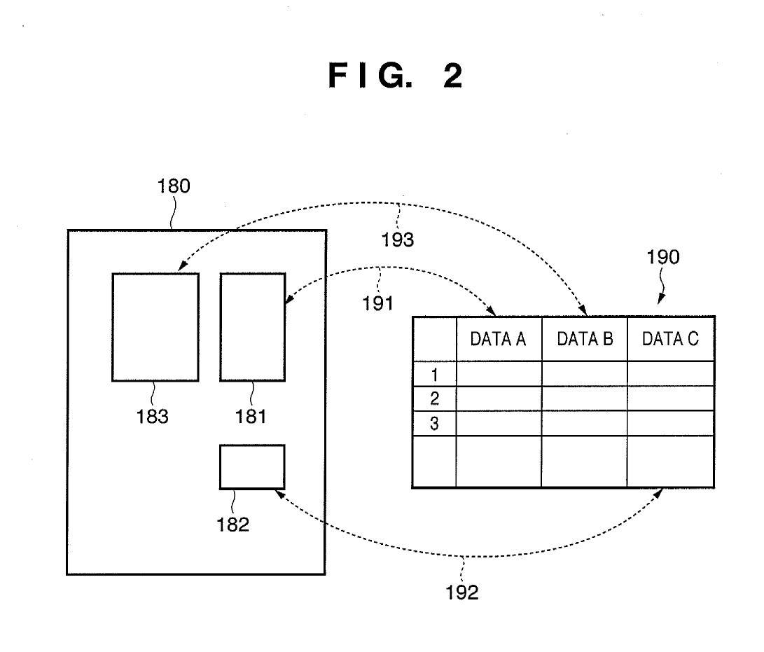

An outline of variable data printing will be explained with reference to FIG. 2.

FIG. 2 is a view for explaining an outline of variable data printing according to the first embodiment of the present invention.

A plurality of containers 181 to 183 are arranged on a page in accordance with an operation instruction from the user via the user interface 103 of the layout editing application 121. Constraints on position and size are assigned to the containers to generate a document template 180.

The user interface 103 associates the document template 180 with a data source 190 (e.g., the database 119), and further associates each container with each data field in the data source 190. Association information representing the association between each container and each data field in the data source 190 is described in the document template 180, and the document template 180 is stored in the HDD 140. The data source 190 is a file which describes item data for each record, and is stored in the HDD 140.

The layout engine 105 loads data associated by association information from the data source 190 into the containers 181 and 182 of the document template 180 in accordance with a print instruction or preview instruction from the user. The layout engine 105 flows the data of each record into the containers (e.g., flows data fields A to C of data record 1 into the containers 181 to 183). The layout engine 105 adjusts the size of each container and the like in accordance with the flowed data (layout adjustment).

For a preview instruction, the layout engine 105 generates a layout-adjusted document image, and outputs it on the screen of the display device 144 so as to display the image as a preview. For a print instruction, the layout engine 105 outputs, as print data to the print server 109, a document image generated using the layout engine 105 or printer driver. By sequentially processing data records 1, 2, 3, . . . , variable data printing is achieved.

<Description of Layout Editing Application>

The layout editing application 121 will be described.

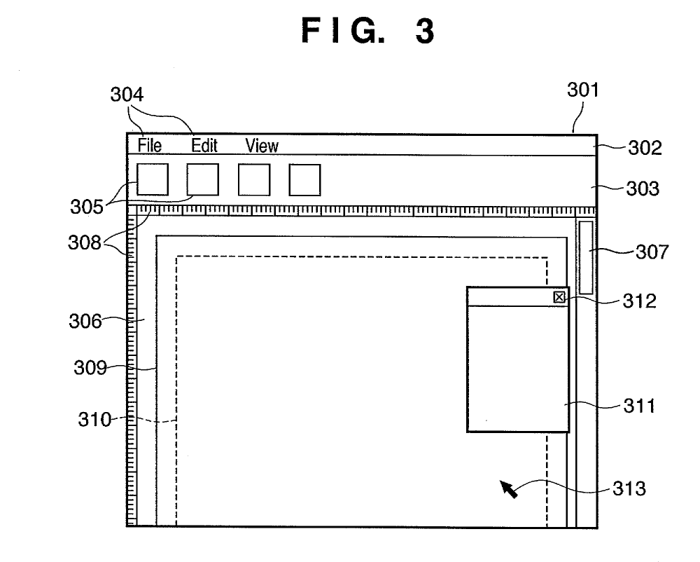

An example of a user interface provided by the user interface 103 will be explained with reference to FIG. 3.

[Main Window]

FIG. 3 is a view showing an example of a user interface according to the first embodiment of the present invention.

As shown in FIG. 3, the user interface 103 displays, on the display device 144, a user interface formed by an application window 301 upon operation. The application window 301 has a menu bar 302, tool bar 303, work area 306, and optional palette 311.

The menu bar 302 and tool bar 303 can be hidden or moved to various locations in the window. The location of the work area 306 can be moved by operating the mouse 133. The palette 311 is an option, and can be controlled to be display/hidden in accordance with a purpose. A cursor/pointer 313 indicates the hotspot of the mouse 133.

As a known technique, the menu bar 302 has many menu items 304 expanded below the layer of a menu option.

The tool bar 303 has many tool buttons and widgets (components) 305 which can be hidden or displayed in a special mode of the application.

A ruler 308 is an option, and is used to indicate the positions of a pointer, page, line, margin guide, container, and object in the work area 306.

A palette 311 is used to access an additional function such as a variable data library. The palette 311 has a window control button 312 for moving/resizing, and closing the palette 311. The palette 311 can be displayed in front of the work area 306 or behind an object. The palette 311 can be displayed only within the application window 301, or displayed partially or entirely outside the application window 301.

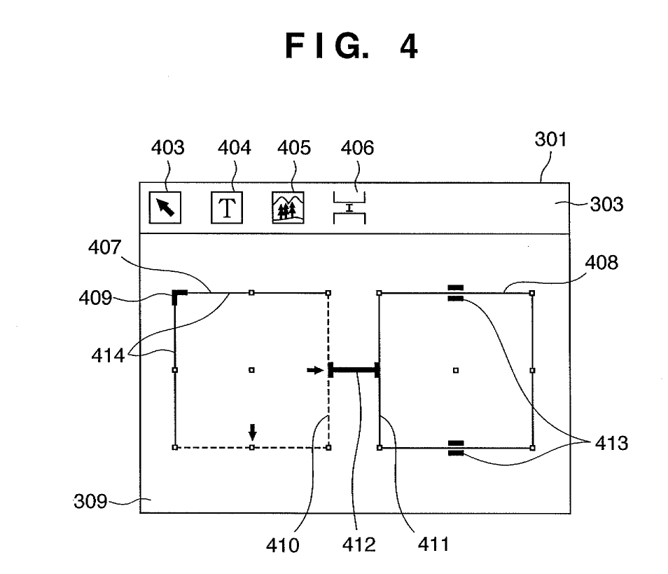

The tool bar 303 has a plurality of types of “buttons” 403 to 406 which can be selected by the user, as shown in FIG. 4.

(1) Selection tool button 403: The button 403 is used to select, move, resize, and lock/unlock the edge of a container. A container is selected by dragging a selection box around the container. A plurality of containers can be selected by selecting and operating them while pressing the CTRL key of the keyboard 132.

(2) Text container tool button 404: The button 404 is used to create a container having a static or variable text.

(3) Image container tool button 405: The button 405 is used to create a container having a static or variable image.

(4) Link tool button 406: The button 406 is used to create a link for associating containers, and also used to control the distance of a link.

As a known technique, these buttons are provided as the tool tips of icons which change in accordance with the operation status.

The application window 301 can determine a basic layout by laying out containers and links in a page. The basic layout is a layout serving as a base for variable data printing. When each container in the basic layout is a fixed layout, the print results of all records have the same layout.

When each container in the basic layout is a variable container, the size and position of the container change in accordance with the amount and size of data loaded from each record under constraints.

Hence, a document template created by the layout editing application 121 determines only the basic layout. When the document template contains a dynamic container, the layout of a finally printed material is adjusted in accordance with loaded data.

[Document Template]

In FIG. 3, the work area 306 is used to display and edit the design of the document template 180 (basic layout) The work area 306 can present an outline of a document to be printed to the user while he designs a document template. From the outline of the document, the user can easily understand how a document merged with the data source 190 changes depending on the amount and size of variable data.

When a data source is associated with a document template, corresponding variable texts and images are displayed in laid-out containers to preview a current document.

A document structure and visual clues (e.g., frame, anchor, slider, and link of a container) for drawing a container in the document template are always displayed when creating the document template. In preview for flowing variable data, visual clues are displayed when the cursor is moved onto a container or a container is selected.

The work area 306 includes a scroll bar 307, the optional ruler 308, and a document template 309. The document template 309 can show that a document has a plurality of pages. The document template 309 corresponds to the document template 180 in FIG. 2.

The page size of a given document template is designated by the user using a known technique. For example, a dialog for setting a page size is displayed by selecting “page setup” from “file” on the menu, and a page size designated by the user is reflected in the dialog.

The number of actual pages of each document may change depending on variable data in an associated data source. In this case, a field which changes in size depending on the variable data amount, like a dynamic table, is set in the document template. That is, in this case, an additional page is automatically created after loading variable data which cannot be fitted in one page.

A boundary 310 displayed in each page is an arbitrary page margin which represents the maximum width of a printable object on the page.

FIG. 4 shows an example of objects which can be displayed in the document template 309 for one page.

Such objects are containers 407 and 408, an arbitrarily applied anchor icon 409, fixed edges 411 and 414, an unfixed edge 410, a link 412, and a slider 413.

The anchor icon 409 can be set at a corner or edge of a rectangular container or at the center of a container. When the anchor icon 409 is set, the position of the set anchor icon 409 is fixed. In the example of FIG. 4, the anchor icon 409 is set at the upper left corner of the container 407. The anchor icon 409 shows that the container can be enlarged to the right or down when variable data is flowed into the container 407 and the image size or text amount of variable data is large.

When the anchor icon 409 is set at an edge, the edge is fixed, and the container can be enlarged along the three remaining edges. When the anchor icon 409 is set at the center of a container, the center position of the container is fixed, and the container can be enlarged in four directions so as not to change the center position of the rectangular container.

Although details of the link 412 will be described later, the link 412 represents that the containers 407 and 408 are associated. The link 412 also represents that the container 408 is movable to the right while maintaining a length (range can be specified) set for the link 412. The slider 413 shows that it is movable parallel to an edge at which the slider 413 is set.

[Container]

A container will be explained as a field area for inserting data of a plurality of types of data fields in each record of the database.

The container is a field area (to be referred to as a partial area) where a fixed or variable text and image (data in a plurality of types of data fields) are flowed from a variable data file into a document template and drawn. The container is laid out together with other containers and objects, as shown in FIG. 4. The container is moved, resized, or created again by operating the mouse 133 in accordance with an operation instruction from the user via the user interface.

More precisely, the container has a set of settings, visual representation, interaction, and editing operation. The definition of the container in the first embodiment will be described.

(1) A container has fixed or variable contents. Variable contents (variable data) can be said to be dynamic in a sense that data acquired from the data source may change for each document, i.e., each record. Note that variable contents in the first embodiment are not intended to be animated contents or contents which change over time by another method because these contents are not suitable for printing.

Similarly, fixed contents are displayed identically for all documents generated using containers. When, however, a link to variable contents is set, fixed contents may change in position in each document under the influence of the variable contents.

(2) A container has decoration functions similar to text settings such as the background color, border, and font style which are applied to contents. These settings will be called container attributes. Although container attributes can be set for each container, the same container attributes as those of a given container can also be set for another container.

(3) A container is merged with data from the data source when generating a document. The decoration function is visible on a printout for any fixed contents. Variable contents provide display of specific data from the data source. This representation of the container can be, for example, printed and/or displayed on the screen of the display device 144.

(4) A container has a user interface as a visual clue, as shown in FIG. 4. For example, a container has an interactive graphical user interface (GUI) for editing a container and setting its display. GUI components are displayed on the screen of the display device 144, but are not printed in a document. The user interface 103 of the layout editing application 121 displays some of the container decoration functions such as the background color and font, and has a function of enabling editing and displaying container settings.

Examples of special purposes of the user interface function are a border, or a corner icon for interactively changing and displaying the size and position of a container. Other examples are a line, an icon, a text, and an overwrite count representing the movement of a container when the container is merged with data from the data source.

[Container Constraints]

The container has constrains on controlling how to link contents displayed in each document. These constraints (including linking of fixed/variable contents to a container) are a major method of controlling generation of many documents from one document template by the user.

An example of the constraints is “the height of contents in this container is 4 inches at maximum”. Another example of the constraints is “the left edge of contents in the container must be displayed at the same horizontal position in respective documents”. The descriptions of the constraints provide various methods for displaying and editing these constraints using the GUI.

A content place holder which designates the layout of fixed contents, like an image having a defined place on a page, is well known in the digital printing technique. A container has a position and size, which are edited and displayed by a method known in a conventional technique. The following description is focused on display and editing by a method specialized in variable data printing.

By using a container, the user can designate the size (drawing size) and position of contents in a document. Since a plurality of types of documents are generated from one document template, many possibilities and constraints are set on a container. For these settings (designation) and display, a predetermined user interface is exploited.

The edge of one container defines a virtual boundary within which associated contents are displayed in a document. Hence, a discussion about the left edge of a container is a discussion about the leftmost edge of an area in which associated contents can be displayed in each document.

Similarly, a discussion about the height of a container is understood to be a discussion about constraints on the height of associated contents in a generated document. In this specification, this distinction will become apparent in a discussion about the edge or size of a container by referring to the user interface 103.

In the following description, the term “fixed” which defines a given value used to constrain display of contents applies to all documents.

(1) When the width of a container is fixed, a width assigned to associated contents is equal in all documents.

(2) When the height of a container is fixed, a height assigned to associated contents is equal in all documents.

(3) When the distance (length of a link) is fixed, a designated distance acts as a constraint in all documents.

(4) When the right and left edges of a container are fixed, the horizontal positions of the edges of a page keep unchanged in all documents. However, the height or vertical position of a container may change. For example, when the left edge of a container is fixed, the display position of associated contents is defined such that the horizontal position of the left edge keeps unchanged in all documents. However, the contents may be displayed at an upper portion on a page in a given document but at a lower portion on a page in another document.

(5) When the upper and lower edges of a container are fixed, the vertical positions of the edges of a page keep unchanged in all documents. However, the width or horizontal position of a container may change in each document.

(6) The vertical axis of a container is a virtual vertical line which is parallel to the right and left edges of the container and positioned between them. If the vertical axis of a container is fixed, the mean (i.e., center position between the right and left edges) of the horizontal positions of the right and left edges of the container remains unchanged in all documents. Under this constraint, the width of a container may change. However, the vertical axis is at the same horizontal position in all documents including a document whose right and left edges are the farthest from the vertical axis and a document whose right and left edges are the closest to the vertical axis. The height and vertical position of a container are not influenced by this constraint.

(7) Similarly, if the horizontal axis is fixed, the mean of the upper and lower edges of a container is set at the same vertical position. However, the width and horizontal position of a container are not influenced by this constraint.

(8) When both the horizontal and vertical axes are fixed, this means that the center position of a container is fixed. However, the width and height of a container are not influenced by this constraint.

(9) When the corner position of a container, the intermediate position of the edge of the container, or the center position of the container is fixed, the fixed position keeps unchanged in all documents. For example, if the upper left corner of a container is fixed, the upper left position of a laid-out container keeps unchanged in all documents.

(10) A vertical edge or axis can be fixed in association with the left or right edge of a page, a left or right page margin, or another horizontal position. Similarly, a horizontal edge or axis can be fixed in association with the upper or lower edge of a page, an upper or lower page margin, or another vertical position.

A term opposite to “fixed” is “variable” which means that the edge, axis, corner, or intermediate position of a container, or a document constraint may change between documents (records). For example, the layout in a page is expected to dynamically change depending on the size and amount of variable data. To the contrary, the size and position of a specific container may be desirably fixed, or the four corners of a container at a corner of a page may be desirably fixed.

To meet these demands, the layout editing application 121 can properly set whether to fix or change an edge, axis, corner, intermediate position, or the like for each container (partial area). The user can create a desired basic layout when he determines the basic layout of the document template 180.

[Display and Editing of Container]

Method of Creating New Container

A container is described as either of two, text and image containers. The text container has a text and embedded image. The image container has only an image.

As shown in FIG. 4, a new text container or image container is created on the document template 309 by clicking the text container tool 404 or image container tool 405 with the mouse 133 and dragging a rectangle onto the document template 309.

Alternatively, a container may be created by making a desired one of the text container tool 404 and image container tool 405 active and simply clicking on the document template 309. In this case, a container of a default size is inserted into the template in accordance with clicking of the mouse 133, and a dialog box or another prompt for setting the dimensions of the new container or the like is provided.

Note that the container size is set by various methods, for example, by automatically defining the container size in advance or creating and laying out a container according to a calculated schema. A generated container is selected with an input device such as a mouse, and an operation of, e.g., designating properties with right clicking is performed. Then, the property dialog of the container is displayed, and constraints can be set on the container.

[Container Display Method]

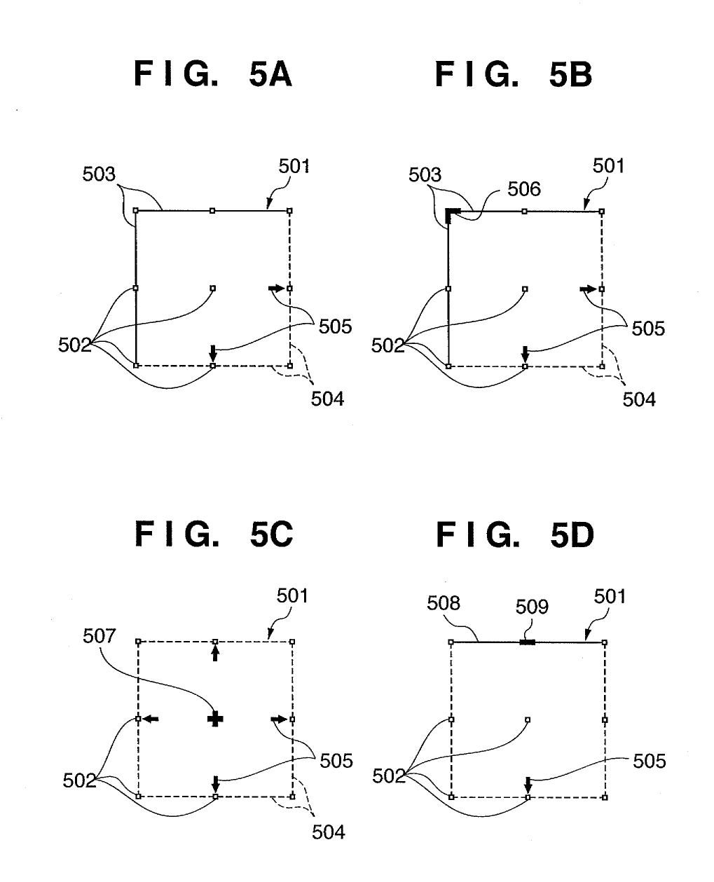

FIGS. 5A to 5D illustrate display rules on the edge of a container.

The layout editing application 121 draws an edge by using a solid line 503 (item) or dotted line 504 in order to represent the state of a container edge. The layout editing application 121 also uses anchor icons 506, 507, and 509 (lines, shapes, or icons drawn near the edge of a container). The layout editing application 121 further uses a handle 502 (control point drawn on or near the edge of an area for movement and modification), the slider 413 (short parallel lines drawn on the two sides of an edge: see FIG. 4), a scaling icon 505, and the color.

The rules of the container display method shown in FIGS. 5A to 5D are as follows.

(1) In order to fix each edge, the edge is drawn in a solid line.

(2) When the width is fixed, the right and left edges are drawn in solid lines.

(3) When the height is fixed, the upper and lower edges are drawn in solid lines.

(4) No axis is drawn.

(5) Scaling icons are drawn near edges which are not drawn by rules (1) to (3), and these edges are drawn in dotted lines.

(6) If vertical and horizontal edges, or vertical and horizontal axes are paired and fixed, an anchor is drawn at the intersection.

(7) If no anchor is drawn on any fixed edge, a slider is drawn at the center of the edge.

(8) If neither anchor nor slider is drawn on a pair of vertical and horizontal edges or vertical and horizontal axes, a handle is drawn at the intersection.

Lines defined by rules (1), (2), and (3) are drawn in solid lines because these lines are fixed or restricted, as described above. A variable edge is drawn in a dotted line, as defined by rule (5). Anchors are displayed at fixed points defined by rules (6), (7), and (8), sliders are displayed on several fixed edges, and handles are displayed for other components.

The above-described rules give priority to a constraint set later by the user. More specifically, when another constraint is set later and the rules influence an edge to be drawn, the drawing contents of solid and dotted lines change. For example, when a container is so small that icons overlap each other or make another display function obscure, the icons may be changed or omitted to draw lines.

The place at which a variable edge is drawn depends on the contents of a container. As will be described later, “dynamic calibration processing” of merging contents into a document template and visualizing them on a user interface is adopted. Instead, a variable edge can be drawn by a means for determining where a variable edge is laid out in a user interface or in the content area of a container averaged in all documents.

These content representations provide a graphic function of displaying the state of each edge of a container. The representations are interpreted as follows.

(1) A dotted line means that the position of an edge in a document changes depending on the contents of a container, like the edge 410 in FIG. 4.

(2) The solid edge 414 means a fixed edge or an edge restricted because the width or height of a container is fixed (the four edges of the container 408 are drawn in solid lines and both the width and height are fixed).

(3) An anchor means that a place where edges or axes cross each other is fixed. Anchor points appear at horizontal and vertical positions in all documents, and anchors are naturally fixed. The icon 409 in FIG. 4 is an example of the anchor icon meaning that the position where the edges 414 cross each other is fixed.

(4) A slider means that the length of an associated edge is fixed but may be translated. For example, the slider 413 in FIG. 4 represents that the contents of the container 408 may be displayed left or right to a position given by a specific diagram in a document.

For example, when the image size or text amount of data flowed into the container 407 associated with the container 408 (link is set between them) is small, the size of the container 407 decreases. Thus, the container 408 is slid (translated) to the left, laid out, and displayed. When the size of the container 407 increases, the container 408 is slid to the right and laid out.

Some or all of these icons and edges are drawn or not drawn depending on which of tools and containers is selected, highlighted, or made active. Generally, the edges and icons of a container are assistance to design a document template, and are not drawn on a printed material.

As described above, the settings of a basic pattern such as the reference, minimum, and maximum values of the width and height of a container are displayed in a secondary dialog window.

In FIG. 5A, both the width and height of a container 501 are not fixed (are variable). A fixed edge 503 is represented in a solid line, and a variable edge 504 is represented in a dotted line. A scaling icon 505 exhibits that the adjacent edge 504 is variable. An indicator in another form is also available instead or additionally.

In FIG. 5B, both the width and height of the container 501 are variable. The anchor icon 506 is added to explicitly represent that the corner position between two crossing edges 503 is fixed.

FIG. 5C shows a state in which both the width and height of the container 501 are variable, and the container 501 can be equally enlarged in directions around the central point, as indicated by an arbitrary anchor icon 507. That is, the container 501 can be enlarged or reduced using the anchor icon 507 as a center. In enlargement/reduction, the layout is adjusted so that the position of the anchor icon 507 always stays at the central point of the container 501.

In FIG. 5D, an upper edge 508 of the container 501 is fixed, but both the width and height are variable. The anchor icon 509 positioned at the center of the upper edge 508 is fixed. The left and right edges (handles 502) of the container 501 move apart from or close to a vertical center axis (vertical axis) passing through the anchor icon 509.

[Link]

A link indicates association between containers. The association represents a distance between containers. When containers associated by a link are influenced by a change in their layout, dynamic layout calculation is executed. For example, the link 412 in FIG. 4 associates the containers 407 and 408 with each other, as described above. The link setting method and the dynamic layout calculation method for containers associated by a link will be described later.

[Link Setting Method]

Setting of a link for associating containers will be explained.

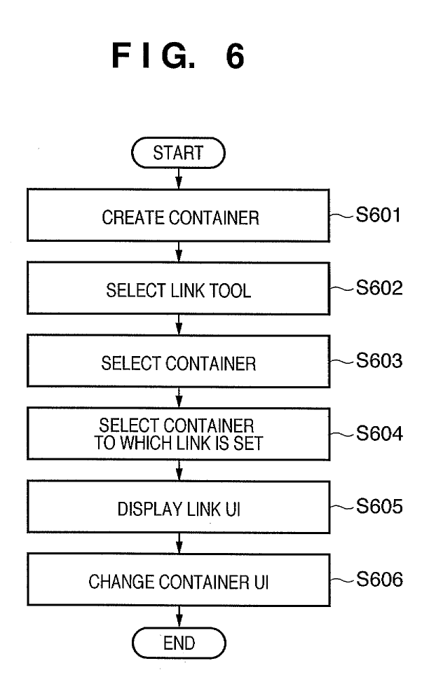

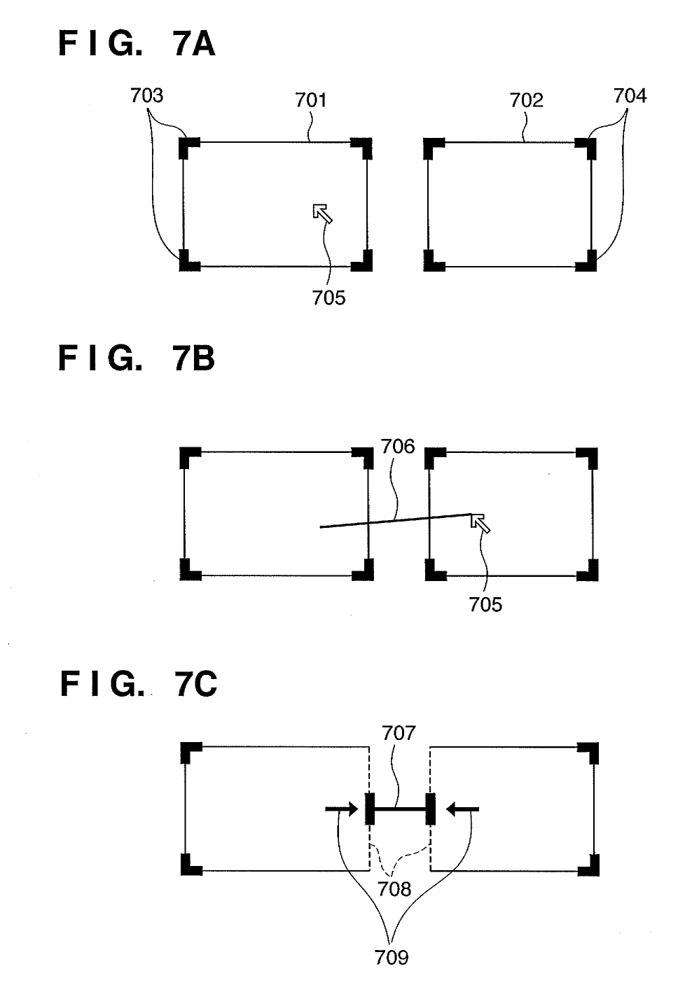

FIG. 6 is a flowchart showing link setting processing according to the first embodiment of the present invention. FIGS. 7A to 7C are views showing transitions of a user interface when setting a link according to the first embodiment of the present invention. The method of setting a link between containers will be explained with reference to FIGS. 6 and 7A to 7C.

In step S601, the layout editing application 121 displays a document template selected as an editing target in the work area 306 of the user interface. To set a link, (at least two) containers between which a link is to be set need to be created on the document template. FIGS. 7A to 7C show transitions of the user interface when creating two containers and setting a link in step S601.

In step S602, the layout editing application 121 selects a link tool (the link tool is selected by clicking the button 406 in FIG. 4).

In FIG. 7A, containers 701 and 702 are made up of fixed edges. Anchors 703 and 704 are identical to the anchor icon 409 in FIG. 4. Reference numeral 705 denotes a mouse pointer.

While the link tool is selected, the user clicks on and selects one (e.g., the container 701) of two containers between which a link is to be set. In response to this operation, the user interface 103 of the layout editing application 121 recognizes that the first container has been selected (step S603), and holds information which specifies the selected container.

A locus corresponding to subsequent movement of the mouse cursor is displayed on the screen. For example, a line segment 706 in FIG. 7B exhibits a line which couples a click position in the state of FIG. 7A to the current position of the mouse pointer 705. This UI can present the user with a position where a link is set.

As shown in FIG. 7B, the user moves the mouse pointer 705 to the other container (container 702) and clicks. In response to this operation, the user interface 103 recognizes that the second container has been selected (step S604), and holds information which specifies the selected container.

The layout editing application 121 sets a link between the first container selected in step S603 and the second container selected in step S604.

After the link is set between the two containers 701 and 702 selected by the user, a link 707 is displayed (step S605). In response to the link setting, the display of the container changes to a state in FIG. 7C (step S606).

More specifically, the container UI automatically changes upon setting the link. In this case, edges associated by the link become variable and are drawn in dotted lines. In FIG. 7C, an edge 708 is drawn in a dotted line and is variable, as described above.

The state of the container edge automatically changes, as shown in FIG. 7C, when it becomes necessary to make the container edge variable upon setting a link, in order to prevent a contradictory state in which all edges are fixed though a link is set. A mark 709 is identical to the scaling icon 505 in FIG. 5, and visually presents the user with a direction in which a container is changeable upon setting a link. In the example of FIG. 7C, the right edge of the left container and the left edge of the right container become variable. However, this is merely an example, and the right container may change to have the slider 413 in FIG. 4.

<Layout Calculation Processing by Layout Engine>

[Layout Calculation Method (Overall Sequence)]

The layout editing application 121 according to the first embodiment has at least two modes. One is a layout mode in which containers are created using the user interface 103 and associated (link is set) with each other to create a layout. The other is a preview mode in which the layout engine 105 inserts each record of the data source into a created layout and previews the layout result actually containing the record.

In the preview mode, an actual record is inserted, and the layout is calculated. In the preview mode, the layout is calculated for display. In actual printing, the layout engine 105 inserts data into each container and calculates the layout. The calculation method at this time is the same as that in the preview mode.

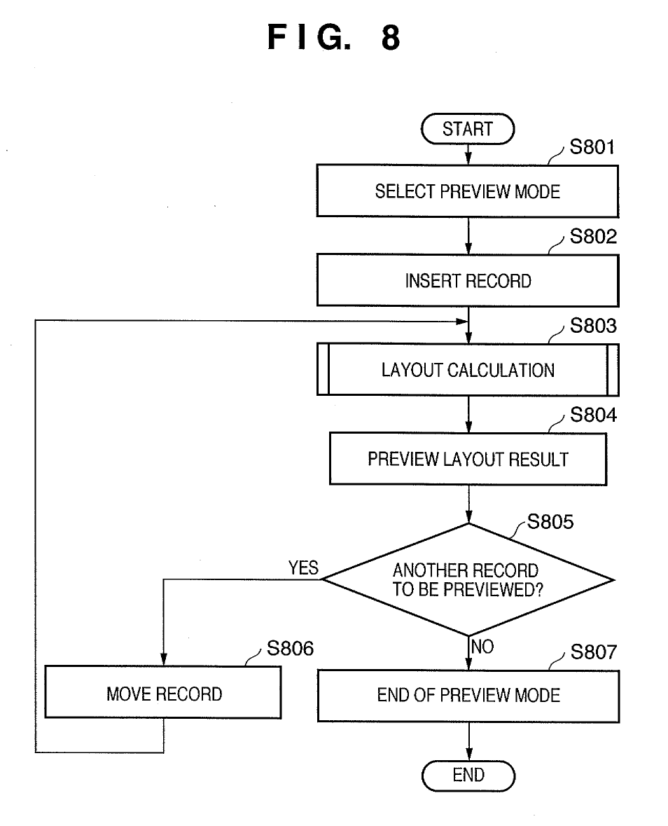

FIG. 8 is a flowchart showing the layout calculation processing according to the first embodiment of the present invention.

The preview mode is selected (step S801). In the preview mode, the layout editing application 121 prompts the user to select a record to be previewed from the data source, and inserts each field data of the selected record into each container (step S802).

After inserting the field data into each container, the layout editing application 121 executes layout calculation for laying out the record, and if necessary, adjusts the layout (step S803). Details of the layout calculation in step S803 will be described later.

The layout editing application 121 displays (previews) the layout calculated in step S803 (step S804). The layout editing application 121 determines, based on an instruction from the user, whether to preview another record (step S805). If the layout editing application 121 determines in step S805 that another record need not be previewed (NO in step S805), the preview mode ends (step S807).

If another record needs to be previewed (YES in step S805), the layout editing application 121 selects another record, executes layout calculation again, and previews the calculated layout (step S806).

In printing, unlike the preview mode, the layout editing application 121 sequentially calculates the layout for all records to be printed. In printing, therefore, step S804 is omitted, and the layout editing application 121 determines in step S805 whether all records to be printed have been processed. In step S803, the layout editing application 121 draws and outputs the layout calculation result, generates it as print data using the printer driver, and outputs the print data to the printer. In this case, the process ends when print data of all records (all records to be printed) are output.

[Layout Calculation Method (Details)]

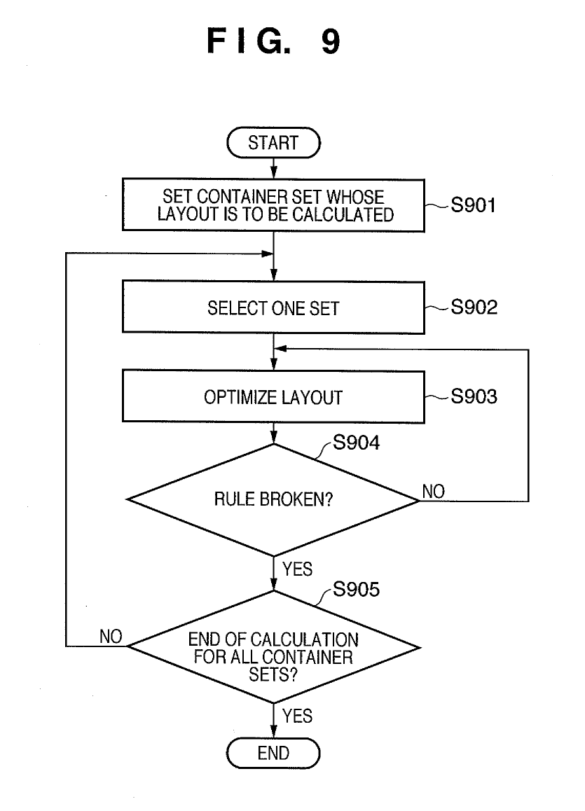

Details of the layout calculation in step S803 will be explained with reference to FIG. 9.

FIG. 9 is a flowchart showing details of layout calculation processing according to the first embodiment of the present invention.

FIG. 9 is a flowchart for explaining only layout calculation processing (dynamic layout calculation processing). This sequence corresponds to layout calculation processing in printing/previewing one record in variable data printing. For a plurality of records, the following process is repeated.

In the dynamic layout calculation processing, the contents of each record are flowed (merged) from the database 119 into (with) a document template. The layout is dynamically calculated in accordance with container attributes and the amounts and sizes of contents. The layout engine 105 of the layout editing application 121 executes the processing in FIG. 9 using the processor 135 and memory 136.

The layout editing application 121 sets a set of containers whose layout is to be calculated (step S901). The layout is calculated by regarding associated containers as one set.

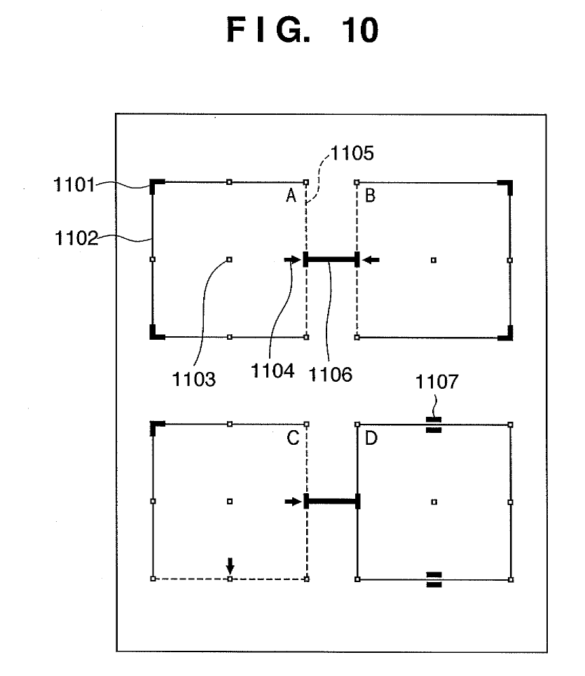

For example, referring to FIG. 10, four containers are laid out on a page and associated with each other. In this case, containers A and B are associated by a link, and containers C and D are associated by a link.

Containers A and B are defined as set 1, and containers C and D are defined as set 2. In other words, containers connected by a link are specified as one set. As described above, reference numeral 1101 denotes an anchor; 1102, a fixed edge; 1103, a controller; 1104, an arrow indicating a direction in which a variable edge changes; 1105, a variable edge; 1106, a link; and 1107, a slider.

The layout editing application 121 selects one of the container sets obtained in step S901 in order to calculate a layout (step S902). The layout editing application 121 calculates the layout of the selected container set.

For two containers A and B serving as variable elements of the selected container set, the layout editing application 121 calculates, from the image size or text amount of data to be flowed, the sizes of containers A and B when each container is free from any constraint.

More specifically, the layout editing application 121 determines whether container A is an image data container or text container. This determination is based on an attribute set for the container, as described above.

Then, the layout editing application 121 loads data to be flowed into container A. When container A is an image data container, the size (the numbers of pixels corresponding to the width and height, and resolution) of the image data is a size when container A is free from any constraint.

When container A is a text container, the amount of text data to be flowed into container A can also be calculated based on the number of characters and character attributes designated by the container attributes of container A. The character attributes include the font type, font size, character pitch, and line pitch.

For a text container, constraints are considered because the aspect ratio of container A cannot be decided unless constraints are taken into consideration. In the example of FIG. 10, anchors are set at the upper and lower left corners of container A, and its height (longitudinal direction) is fixed. The layout editing application 121 determines whether characters of a calculated data amount (text amount) can be flowed into container A having a width (lateral direction) set as the basic pattern of container A.

If the layout editing application 121 determines that all characters can be flowed into container A, the size (width and height) of container A that is set by the basic pattern need not change. If the layout editing application 121 determines that all characters cannot be flowed into container A, container A extends in the lateral direction because the height is fixed by anchor setting. The layout editing application 121 calculates the size of container A by calculating the width of container A at which characters of the calculated data amount can be flowed.

The layout editing application 121 optimizes the layout to minimize the difference between the size of a laid-out container and that of actual contents (step S903).

The layout is optimized so that the difference between the layout size and the size of contents to be inserted into a container is minimized in each of containers which are so associated as to dynamically change their sizes.

The layout editing application 121 calculates the size of the container set that is calculated in step S902, i.e., the total size of containers A and B and link 1106 (fixed link in this case). The layout editing application 121 calculates the difference between the total size and the size (corresponding to the distance between the anchor icons of containers A and B in the example of FIG. 10) of the container set in the basic layout. When containers A and B become wide, the difference value changes if it has been calculated in a previous step. The layout editing application 121 adjusts the layout by equally distributing the difference value to respective elements of the container set.

The layout editing application 121 optimizes the layout, and determines whether the layout breaks the rules (step S904). If the layout does not break rules (YES in step S904), the process proceeds to step S905. If the layout breaks the rules (NO in step S904), the process returns to step S903 to calculate the layout again so as not to break the rules.

The rules are constraints set by the user in creating a layout, and include constraints on the variable range of the size of a container, the position of the container, and change of the link length for a variable link. After the layout editing application 121 calculates the layout so as not to break the rules, the layout of the set is complete.

The layout editing application 121 performs the processes in steps S902 to S904 for all sets on the page, and determines whether the layout of the entire page has been calculated (step S905) If the calculation has not ended (NO in step S905), the process returns to step S902. If the calculation has ended (YES in step S905), the process ends.

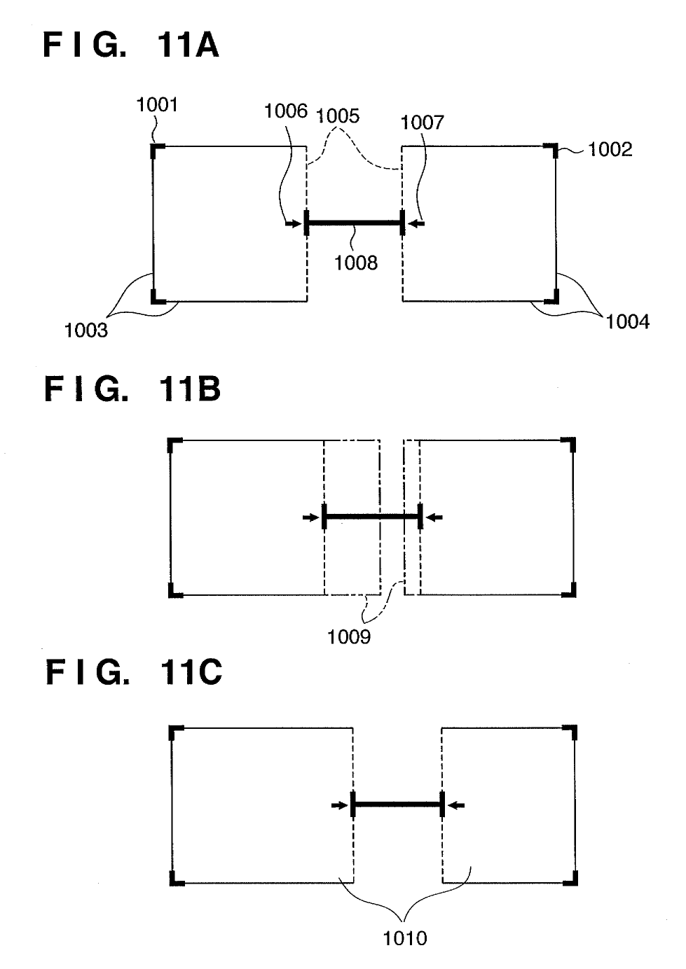

An example of a UI in the above-described layout calculation will be explained with reference to FIGS. 11A to 11C.

FIGS. 11A to 11C are views showing an example of a user interface in layout calculation processing according to the first embodiment of the present invention.

FIG. 11A shows a state in which a given record is inserted and the layout is determined. Reference numerals 1001 and 1002 denote anchors; 1003 and 1004, fixed edges; 1005, a variable edge; 1006, an arrow indicating a direction in which a variable edge changes; and 1008, a link. In this state, the record is changed, and contents of different sizes are inserted.

FIG. 11B shows the size of new contents over the state of FIG. 11A. Reference numeral 1009 denotes a size of contents inserted into each container. After that, the layout is calculated.

FIG. 11C shows the result of layout calculation. The size of each container is calculated to have the same difference as that of the size of contents to be actually inserted, without breaking the above-mentioned rules. As shown in FIG. 11C, the inserted-content size 1009 shown in FIG. 11B and a calculated content size 1010 have the same difference.

[Setting of Variable Link]

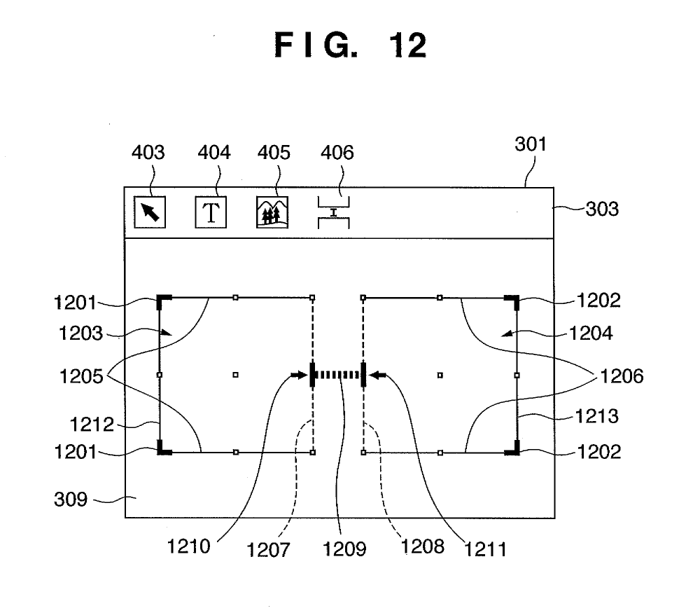

FIG. 12 is a view showing an example of a user interface for setting a variable link according to the first embodiment of the present invention.

In FIG. 12, similar to FIG. 4, the user interface provides the application window 301 and tool bar 303. In the state of FIG. 12, containers 1203 and 1204 exist on the document template 309. The container 1203 includes anchor icons 1201 and fixed edges 1205, and the container 1204 includes anchor icons 1202 and fixed edges 1206.

A variable-size link 1209 is set between the containers 1203 and 1204 and links them. Since the link 1209 is set between the containers 1203 and 1204, a right edge 1207 of the container 1203 and a left edge 1208 of the container 1204 are represented in broken lines. Indicators 1210 and 1211 are displayed on the respective containers to represent that the edges 1207 and 1208 are variable.

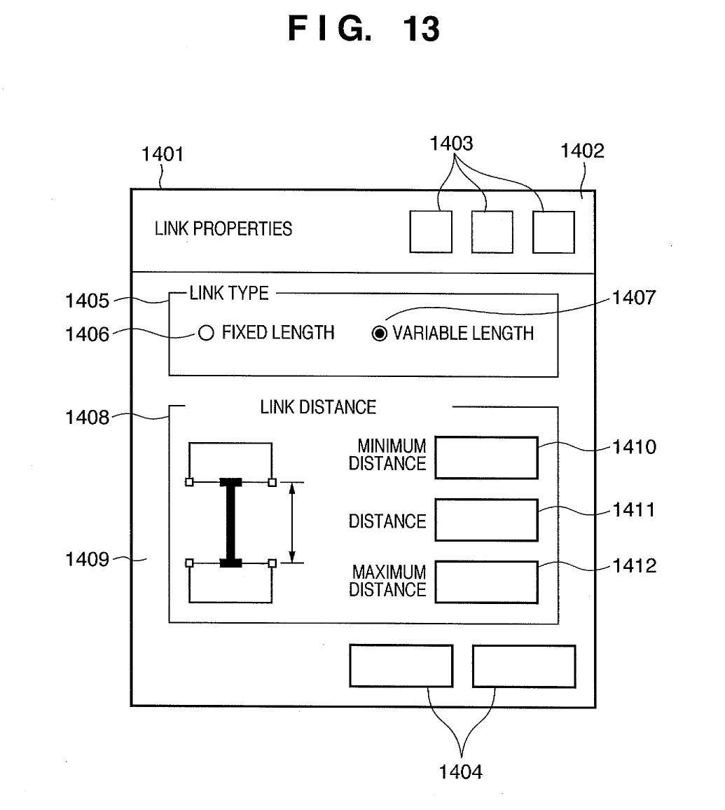

FIG. 13 is a view showing an example of a user interface for implementing a link setting function according to the first embodiment of the present invention.

FIG. 13 shows an example of a dialog window 1401 serving as a user interface for setting information (link property) of the link 1209. The dialog window 1401 includes a title bar 1402, tool buttons 1403, buttons 1404 for opening and closing the dialog window 1401, and an area 1409 for setting various pieces of information.

The dialog window 1401 has a link type field 1405 made up of radio buttons for alternatively selecting whether the link type is a link of a variable length 1407 or a fixed length 1406.

When the link type is a variable-length link, the dialog window 1401 displays a link distance field 1408 made up of a minimum value field 1410 (minimum distance), maximum value field 1412 (maximum distance), and reference value field 1411 (distance) for the link length.

The dialog window 1401 in FIG. 13 appears when a link is set between two containers by, e.g., the link setting operation described with reference to FIGS. 6 and 7A to 7C, and then the set link is selected by an operation such as clicking. Alternatively, immediately after a link is set, the dialog window 1401 relevant to the link may appear automatically. The reference value of the distance between containers is a link length used when the size of each container does not change upon flowing data into it.

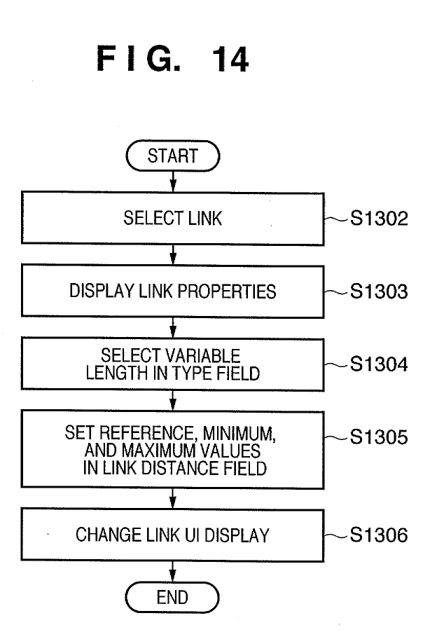

A variable link setting method will be explained with reference to FIG. 14.

FIG. 14 is a flowchart showing variable link setting processing according to the first embodiment of the present invention.

For example, when a link is set between two containers A and B in FIG. 10 by the link setting operation described with reference to FIGS. 6 and 7A to 7C, a link of a fixed size is set. By selecting this link and executing the processing shown in FIG. 14, the link can be changed from the fixed-size link 1106 (FIG. 10) to the variable-size link 1209 (FIG. 12).

First, the user selects a desired link (e.g., the link 1106 in FIG. 10) with the mouse 133 (step S1302). Then, the user executes a predetermined operation to display link properties. In response to this, the user interface 103 of the layout editing application 121 displays the dialog window 1401 (FIG. 13) corresponding to the selected link (to be referred to as a target link hereinafter) (step S1303).

Note that the link selection operation is arbitrary such as right clicking of the mouse 133 or an operation to a specific key of the keyboard 132, similar to the setting of the basic pattern of a container.

The displayed dialog window 1401 presents the current state of the selected link. In this example, since the link 1106 is selected, the link size is fixed at this stage, and the distance 1406 representing a fixed length is selected in the link type field 1405.

To change the link from a fixed size to a variable one in the dialog window 1401, the user selects the variable length button 1407 in the link type field 1405 to make the link size variable (step S1304).

In response to this selection, the maximum distance field 1412, minimum distance field 1410, and reference value field 1411 in the link distance field 1408 are enabled to allow setting numerical values. To set a variable size of the link, the user sets the maximum value of the link length in the maximum distance field 1412, the minimum value in the minimum distance field 1410, and the current value in the reference value field 1411 (step S1305).

After the end of the settings, the user designates application of the settings with the general dialog window opening and closing buttons 1404. When the user interface 103 detects this designation, it reflects the settings on the target link. As a result, the link UI display changes to a state as represented by the link 1209 in FIG. 12 (step S1306).

The setting information in the dialog window 1401 is stored in, e.g., the memory 136.

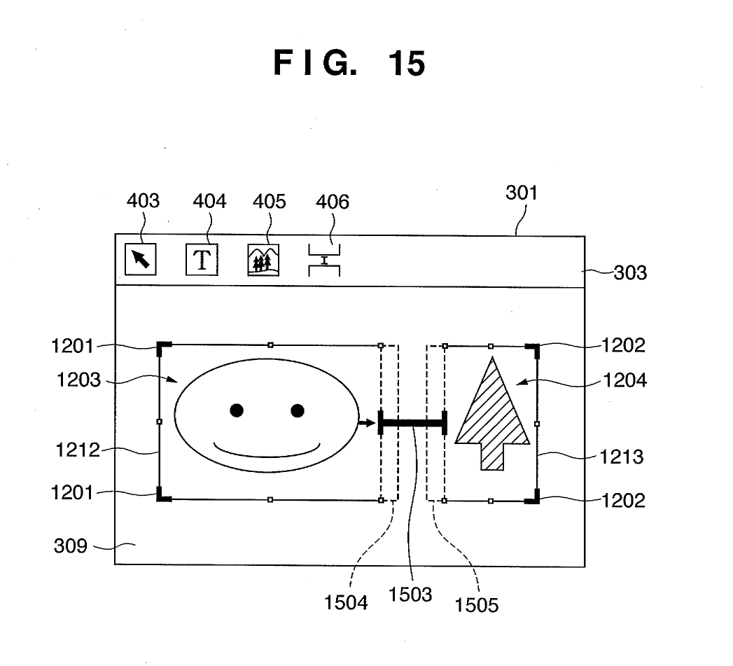

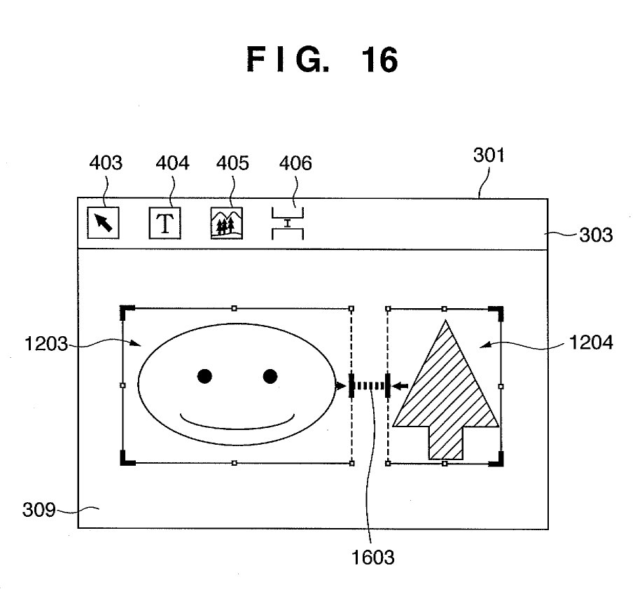

An example of a layout result will be explained with reference to FIGS. 15 and 16.

FIG. 15 is a view showing a layout result when a fixed-size link is used according to the first embodiment of the present invention. Data for displaying a layout result of flowing contents into a container on the basis of container attributes is stored in a storage device such as a memory or hard disk.

The layout is calculated in the same way as that described above. Assume that image data of different sizes are inserted into the containers 1203 and 1204 in FIG. 15. In this case, the sizes of data to the respective containers are regarded optimal. The container 1203 tries to change its size to the right so as to move close to a frame 1504 (optimal container size) corresponding to the size of the inserted image. Similarly, the container 1204 tries to change its size to the left so as to move close to a frame 1505 (optimal container size) corresponding to the size of the inserted image.

However, a left edge 1212 of the container 1203 and a right edge 1213 of the container 1204 cannot move owing to the anchor icons 1201 and 1202. To change the sizes of the containers 1203 and 1204, the interval between them must be decreased. However, a fixed-size link 1503 is set between the containers 1203 and 1204, and the length of the link 1503 is maintained in layout calculation. Thus, the sizes of the containers 1203 and 1204 are changed.

As a result, the containers 1203 and 1204 cannot ensure sizes each optimal for the aspect ratio of data, and finally become smaller than the optimal sizes (frames 1504 and 1505), as shown in FIG. 15. In other words, since the size of the link 1503 is fixed, the containers 1203 and 1204 cannot achieve their optimal sizes (in FIG. 15, the range indicated by a chain line in each container exhibits the aspect ratio of data).

FIG. 16 shows a layout result when the link is set to a variable size in the same state as that in FIG. 15.

In this case, a variable-size link 1603 is set between the containers 1203 and 1204 in the above example. When changing the sizes of the containers 1203 and 1204, the link can shorten to increase the sizes of the containers 1203 and 1204 more than those in the example of FIG. 15.

Hence, a size optimal for the size of inserted data can be achieved, or a container frame close to the size (optimal size) of inserted data can be set. FIG. 16 shows the result of this layout. The variable link 1209 in FIG. 12 changes to a size represented by the variable link 1603 as a result of layout calculation. In this case, the containers 1203 and 1204 attain optimal sizes (sizes matching their data sizes).

A characteristic configuration of the first embodiment will be explained.

In the first embodiment, a document is created by arranging database records or the like in containers (partial areas to which data are flowed: also called field areas) defined in a document template (also simply called a template).

In the first embodiment, not only data are arranged in accordance with the template, but also part of a document is created in accordance with the template. The first embodiment provides a function (multirecord function) of completing a document by inserting part of the document into an area (called a flow area) separately defined in a template. The number of insertable document parts is not limited to one for one flow area. When a plurality of flow areas are defined in the document template, created document parts can also be distributed to the respective flow areas under a predetermined condition.

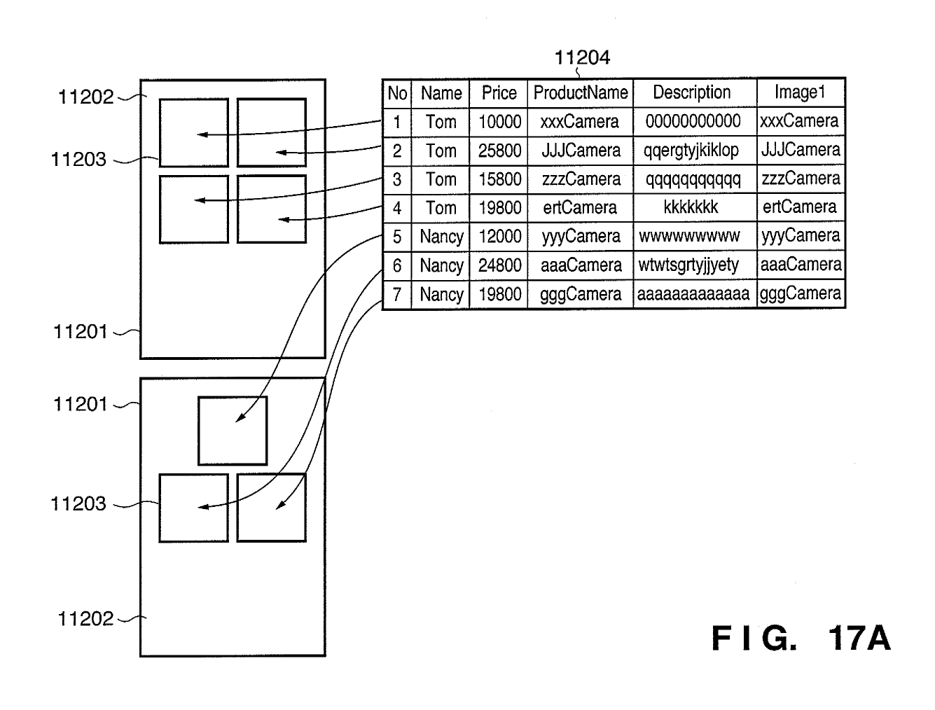

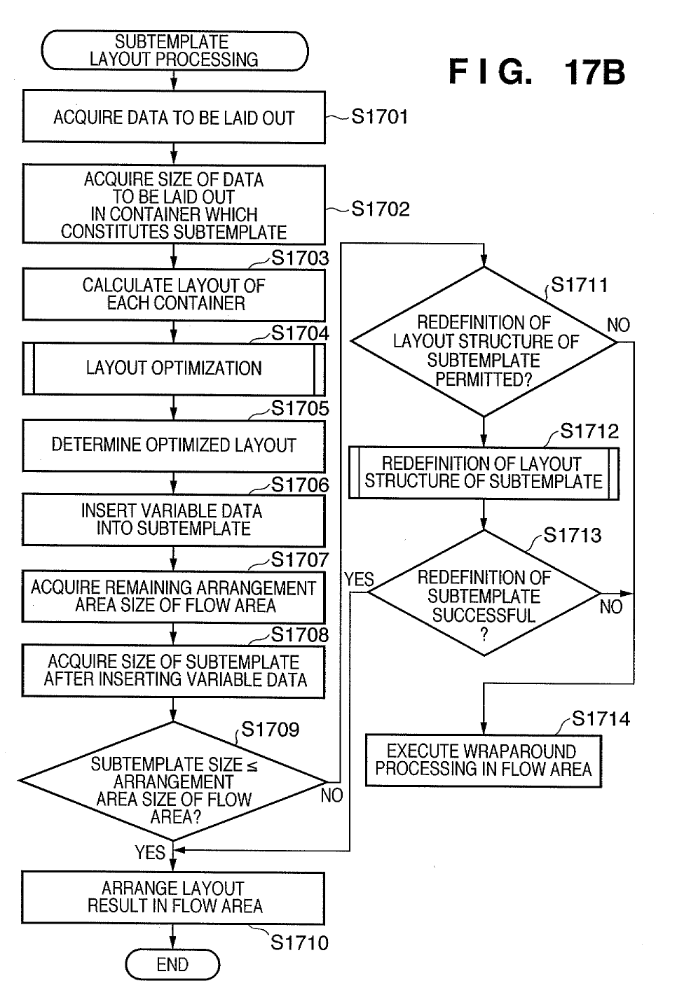

The multirecord function will be explained with reference to FIG. 17A.

<Multirecord (Multidata) Function>

FIG. 17A is a view for explaining the multirecord function according to the first embodiment of the present invention.

In a normal document template (FIG. 2), one record corresponds to one document. In contrast, multiple records corresponding to subtemplates are kept flowed until a break at which the reference item changes appears. Hence, a plurality of records are inserted into one document. A database of variable data corresponding to a normal document template is desirably different from a multirecord database of variable data corresponding to a subtemplate.

FIG. 17A shows an outline of multiple records and a layout method for them. Reference numeral 11201 denotes a document; 11202, a page; 11203, a subtemplate; and 11204, a database. In FIG. 17A, the database 11204 includes records 1 to 7. In normal variable printing of laying out one record in one document, seven documents are created because the database 11204 has seven records.

In variable printing which supports the multirecord function of laying out multiple records in one document, the following processing is executed. First, the user designates a column (field) serving as a reference item for designating multiple records. The designated column is called a key column.

The key column is sometimes called a multidata condition. In this case, a column with a field name: Name is designated as the key column. Then, records having the same value in the designated field are laid out in one document.

In this example, records 1 to 4 have the same value “Tom” in the Name field serving as the key column, and are laid out in one document. Since records 5 to 7 have the same value “Nancy” in the Name field, a break occurs, and records 5 to 7 are laid out in another document (see FIG. 17A). Records having different values in a designated field are laid out in different documents.

Document pages 11202 in FIG. 17A are created with different layouts because the number of records is different between documents. How to lay out multiple records in subtemplates depending on the number of records is based on, e.g., attributes information of the flow area. For example, when the flow area has four subtemplates, multiple records are laid out as represented by the upper layout in FIG. 17A. When the flow area has three subtemplates, multiple records are laid out as represented by the lower layout in FIG. 17A.

When subtemplates are arranged in the flow area in the document template, an unwanted space may be generated in the flow area depending on the subtemplate size, impairing the appearance.

If the size of a subtemplate exceeds that of a flow area where the subtemplate is to be laid out, wraparound of the subtemplate occurs (the subtemplate moves to a free space), increasing the number of output pages or generating a blank the user does not want. To prevent an output result the user does not want, a subtemplate which assumes a shortage of the flow area size needs to be prepared.

From this, according to the first embodiment of the present invention, a data layout defined in a subtemplate changes in accordance with the size of the flow area when the flow area size is smaller than the subtemplate size.

Subtemplate layout processing according to the first embodiment will be explained with reference to FIG. 17B.

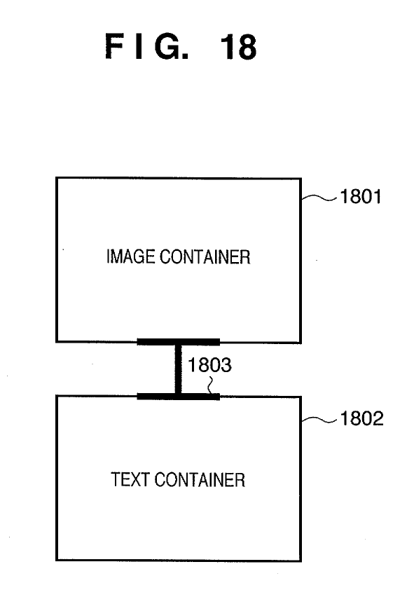

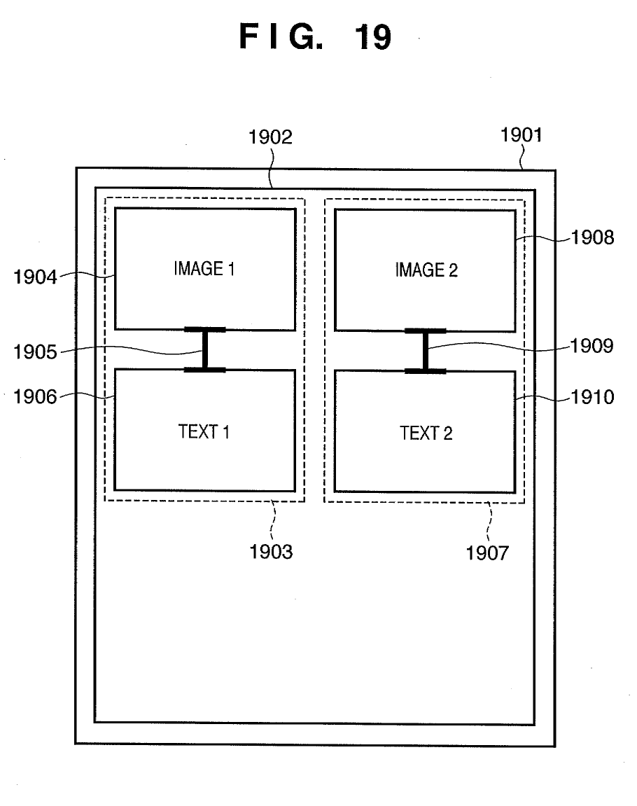

FIG. 17B is a flowchart showing subtemplate layout processing according to the first embodiment of the present invention. FIG. 18 is a view showing an example of a subtemplate set in the flow area of a document template according to the first embodiment of the present invention. FIG. 19 is a view showing an arrangement of inserting variable data into the subtemplate in FIG. 18 and arranging the subtemplate in the flow area of a document template according to the first embodiment of the present invention.

The flowchart of FIG. 17B will be described with reference to the concrete examples of FIGS. 18 and 19.

FIG. 18 shows a simple subtemplate prepared by associating an image container 1801 and text container 1802 with a link 1803. The subtemplate is template data in which an image container, text container, and the like are laid out. The subtemplate is saved after setting data (variable data) in the database that is assigned to a laid-out container. Data themselves are not particularly different from those for a normal document template.

The subtemplate is convenient when the same layout is used many times in one document or applied to another document. A link can be set between image and text containers arranged in the subtemplate. The layout size (also position) can be optimized depending on data to be laid out.

Subtemplates are templates which can be successively arranged in only a flow area defined in a document template. The subtemplate is often used when the same layout is used many times in one document template.

Containers arranged in a subtemplate are identical to image and text containers directly arranged in the document template. As described with reference to FIGS. 15 and 16, the layout size can dynamically change depending on data to be laid out.

Variable data is flowed into a subtemplate in steps S1701 to S1706 of FIG. 17B.

In step S1701, the layout editing application 121 acquires data to be laid out. In step S1702, the layout editing application 121 acquires the size of data to be laid out in each container of the subtemplate. In step S1703, the layout editing application 121 calculates the layout of each container on the basis of the acquired data size.

In step S1704, the layout editing application 121 optimizes the layout of each container in the subtemplate. The layout optimization method is the same as that shown in FIGS. 8 and 9. In step S1705, the layout editing application 121 determines the layout optimized in step S1704. In step S1706, the layout editing application 121 inserts variable data into each container laid out optimally.

By processes in step S1707 and subsequent steps, a subtemplate is flowed into a flow area.

In step S1707, the layout editing application 121 acquires the current remaining size (arrangement area size) of the flow area into which the subtemplate is flowed. The acquired size information includes the width and height of the flow area.

In step S1708, the layout editing application 121 acquires the size of the subtemplate (subtemplate after inserting variable data) in which variable data has been inserted into each container in step S1706. The acquired size information includes the width and height of the subtemplate after inserting variable data.

In step S1709, the layout editing application 121 compares the flow area size acquired in step S1707 with the subtemplate size acquired in step S1708. At this time, if the size (width or height) of the subtemplate is equal to or smaller than that of the flow area (YES in step S1709), the layout editing application 121 determines that the subtemplate can be flowed into the flow area. In step S1710, the layout editing application 121 flows the subtemplate into the flow area, and arranges the layout result in the document.

If the layout editing application 121 determines in step S1709 that the size of the subtemplate is larger than that of the flow area (NO in step S1709), it determines that no subtemplate can be flowed into the flow area. In step S1711, the layout editing application 121 determines whether to redefine the layout structure of the subtemplate to a size matching the flow area. In other words, the layout editing application 121 determines whether the layout structure of the subtemplate can be redefined.

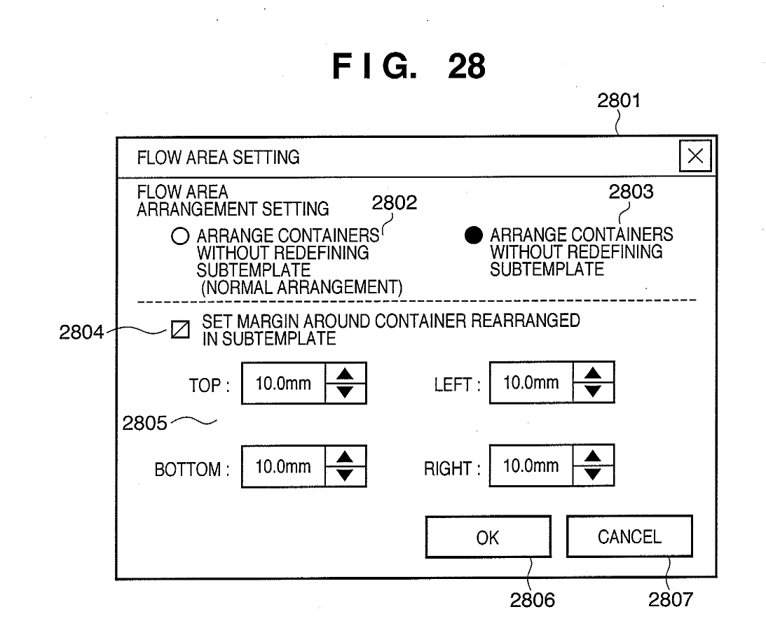

Especially, the present invention provides a user interface (FIG. 28) for designating a setting of whether to redefine the layout structure of a subtemplate. Although details of the user interface will be described later, the user interface allows setting whether to permit/inhibit redefinition of the layout structure of a subtemplate.

Thus, in step S1711, the layout editing application 121 determines whether to permit redefinition of the layout structure of the subtemplate. In this determination, the layout editing application 121 determines, based on setting information made via the user interface of FIG. 28, whether the user designates the setting of redefining the layout structure of the subtemplate in accordance with the flow area.

If the layout editing application 121 determines in step S1711 that redefinition of the layout structure of the subtemplate is inhibited (NO in step S1711), the process proceeds to step S1714. In step S1714, the layout editing application 121 performs wraparound processing of moving the subtemplate to a position where it can be arranged in the flow area.

The wraparound processing for the subtemplate in the flow area will be described later.

If redefinition of the layout structure of the subtemplate is permitted (YES in step S1711), the layout editing application 121 redefines the layout structure of the subtemplate in step S1712. Redefinition of the layout structure of the subtemplate will be described later.

In step S1713, the layout editing application 121 determines the result of redefining the layout structure of the subtemplate that matches the size of the flow area in step S1712. In this determination, the layout editing application 121 determines whether redefinition of the layout structure is successful. If redefinition of the layout structure of the subtemplate is successful (YES in step S1713), the process proceeds to step S1710. In step S1710, the layout editing application 121 flows the subtemplate into the redefined flow area, and arranges the layout result in the document.

If the layout editing application 121 determines in step S1713 that redefinition of the layout structure of the subtemplate fails (NO in step S1713), the process proceeds to step S1714. In step S1714, the layout editing application 121 performs wraparound processing of moving the subtemplate to a position where it can be arranged in the flow area.

A concrete example of processing of flowing a subtemplate into a flow area will be explained with reference to FIG. 19.

FIG. 19 shows an example in which two variable data are normally flowed into a flow area 1902 in a document 1901 via subtemplates 1903 and 1907 each having the layout structure shown in FIG. 18.

Variable data is flowed into the subtemplate 1903 in which a link 1905 links an image container 1904 and text container 1906. Also, variable data is flowed into the subtemplate 1907 in which a link 1909 links an image container 1908 and text container 1910.

Since the total size of the subtemplates 1903 and 1907 is smaller than the size of the flow area 1902, the subtemplates 1903 and 1907 are arranged side by side in the horizontal direction in the document 1901.

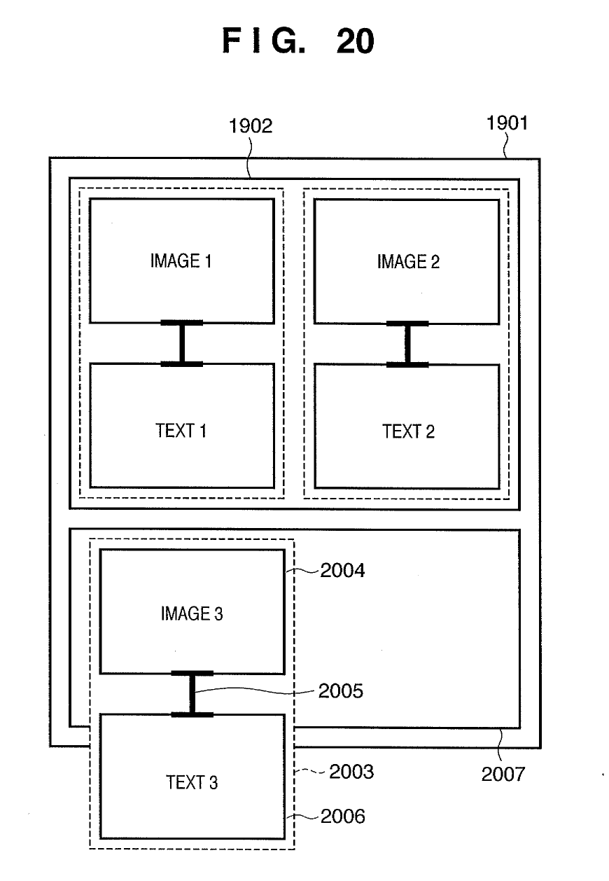

FIG. 20 shows a case where another subtemplate is arranged in the document 1901 in the state of FIG. 19. The flow area 1902 has already been defined in the document 1901. In general, a subtemplate 2003 which defines an image container 2004, a text container 2006, and a link 2005 between them is newly arranged in the document 1901 by flowing the subtemplate 2003 into a flow area 2007.

In this case, the height of the subtemplate 2003 exceeds that of the flow area 2007, the subtemplate 2003 cannot be arranged in the document 1901. According to a conventional method, subtemplate wraparound processing is done in this situation. The subtemplate wraparound processing will be described later.

To the contrary, according to the present invention, it is determined in step S1711 of FIG. 17B whether to redefine the layout structure of the subtemplate 2003 exceeding the flow area 2007. Based on the determination result, the layout structure is redefined, and the subtemplate having a more proper layout structure can be arranged.

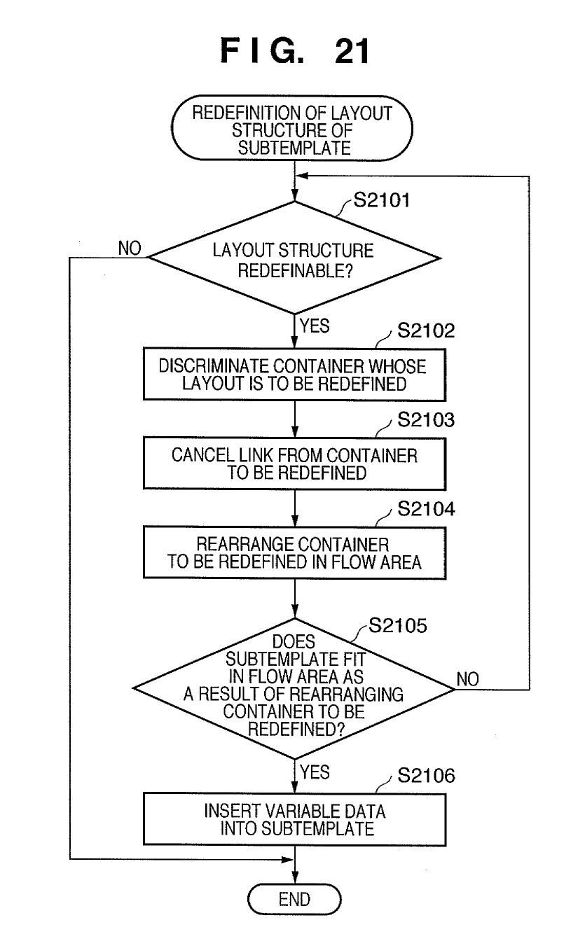

Redefinition processing (step S1712) for the layout structure of a subtemplate will be explained with reference to FIG. 21.

FIG. 21 is a flowchart showing redefinition processing for the layout structure of a subtemplate according to the first embodiment of the present invention.

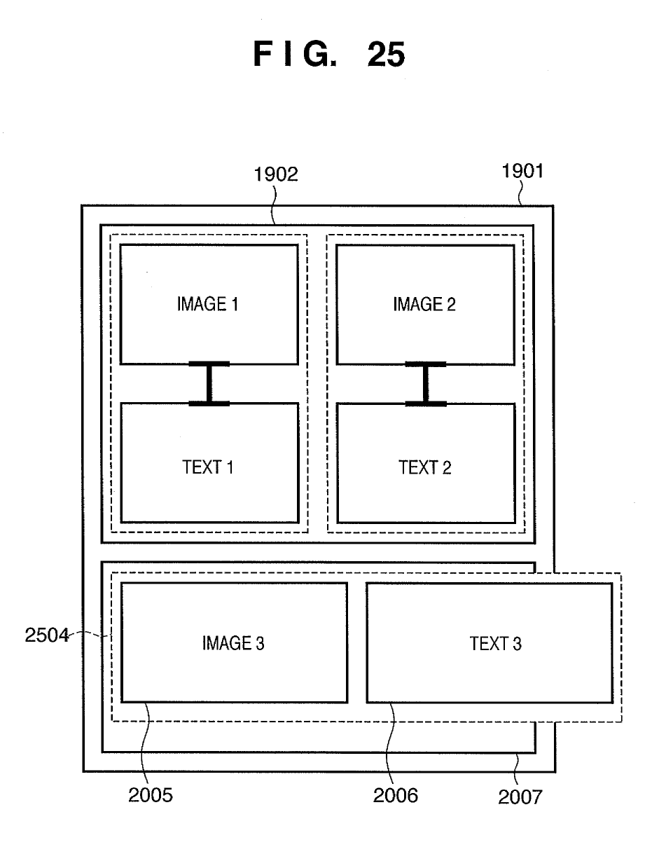

In step S2101, the layout editing application 121 determines whether the layout structure of the subtemplate can be redefined. If the layout structure of the subtemplate can be redefined (YES in step S2101), the process proceeds to step S2102. If the layout structure of the subtemplate cannot be redefined (NO in step S2101), the layout editing application 121 returns the layout structure of the subtemplate to one before redefinition, and the process ends. A concrete case where no layout structure can be redefined will be described with reference to FIG. 25. Particularly in the example shown in FIG. 25, redefinition of the layout structure of a subtemplate fails.

In step S2102, the layout editing application 121 discriminates a container whose layout is to be redefined.

In the example of FIG. 21, the layout editing application 121 discriminates, based on the layout structure of the subtemplate 2003, a container which makes the size of the subtemplate 2003 exceed the size (height) of the flow area 2007. In this case, the height of the subtemplate 2003 exceeds that of the flow area 2007 owing to the text container 2006. Thus, the layout editing application 121 discriminates the text container 2006 as a container to be redefined.

In the first embodiment, in step S2102, the layout editing application 121 redefines the layout structure of the text container 2006 so that the size of the defined subtemplate 2003 matches that of the flow area 2007. However, the text container 2006 is connected to the image container 2004 via the link 2005. In this case, the layout structure is redefined including all links and containers connected to the text container 2006.

In step S2103, the layout editing application 121 removes the link from the container whose layout structure is to be redefined.

In the example of FIG. 20, the layout editing application 121 removes the link 2005 from the text container 2006 whose layout structure is to be redefined. Then, the link 2005 becomes invalid, and the layout editing application 121 similarly removes the link 2005 from the image container 2004.

In step S2104, the layout editing application 121 rearranges, in the flow area, the container to be redefined from which the link is removed.

In the example of FIG. 20, the layout editing application 121 rearranges, in the flow area 2007, the image container 2004 and text container 2006 from which the link 2005 is removed.

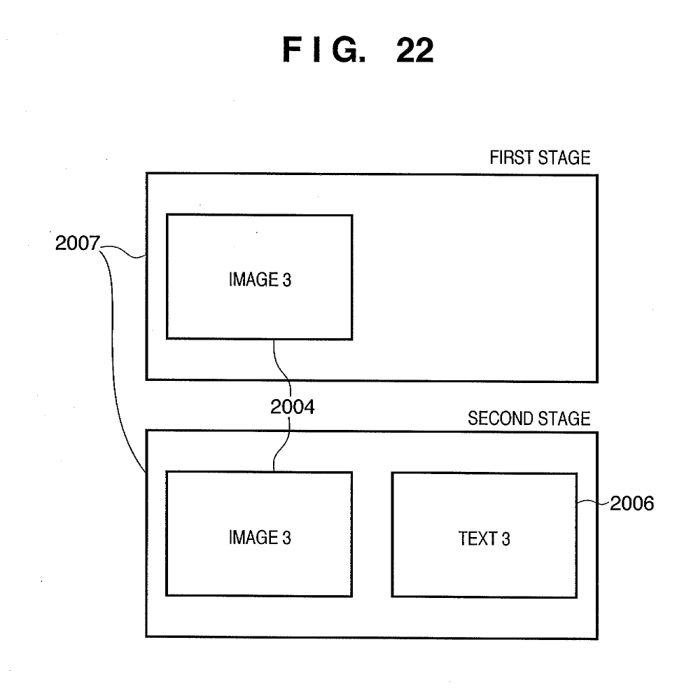

The process of rearranging a container in step S2104 will be explained with reference to FIG. 22.

FIG. 22 is a view for explaining the process of rearranging a container according to the first embodiment of the present invention.

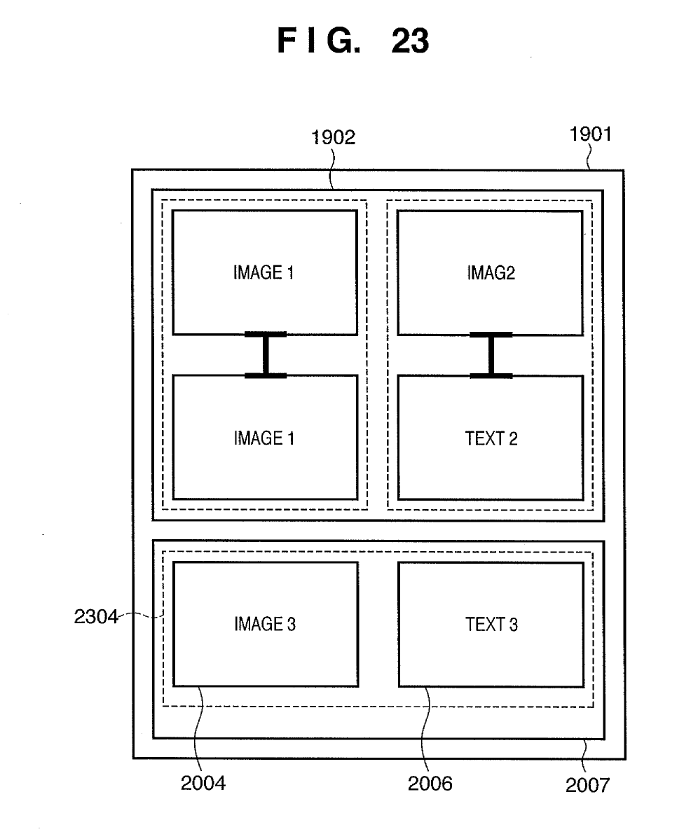

In FIG. 22, the image container 2004 is arranged in the flow area 2007. The text container 2006 whose layout structure is to be redefined is arranged in a free space of the flow area 2007. As a result, the container arrangement as shown in FIG. 20 changes to one shown in FIG. 23. That is, FIG. 23 shows the result of redefining, in step S2104, the layout structure of the subtemplate 2003 in the document 1901 in the state shown in FIG. 20.

By the process in step S2104, the image container 2004 and text container 2006 containing variable data are arranged in the flow area of the document 1901 with a layout structure different from the one originally defined for the subtemplate 2003.

In response to this, the subtemplate 2003 is deformed to a subtemplate 2304 matching the size of the flow area 2007. Variable data of three records can be properly flowed into the document 1901.

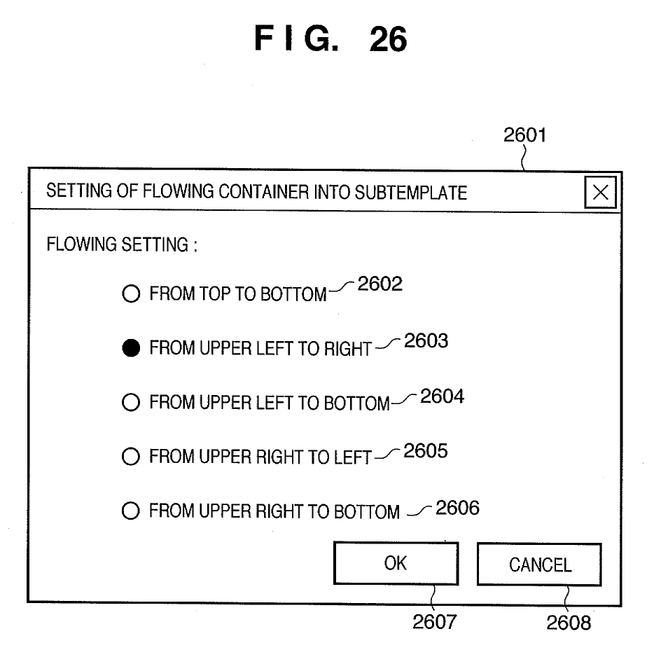

In step S2104, a position where a container is arranged in the flow area, and the arrangement order of containers in the flow area are set via a user interface (FIG. 26) to be described later.

Referring back to FIG. 21, in step S2105, the layout editing application 121 determines whether the subtemplate fits in the flow area as a result of redefining the layout structure of the container by the process of step S2104. If the subtemplate fits in the flow area (YES in step S2105), the process proceeds to step S2106. In the example shown in FIG. 23, the subtemplate 2304 fits in the flow area 2007.

In step S2106, the layout editing application 121 inserts variable data into each container in the redefined layout.

If the subtemplate does not fit in the flow area (NO in step S2105), the process returns to step S2101 to determine again whether the layout structure can be redefined.

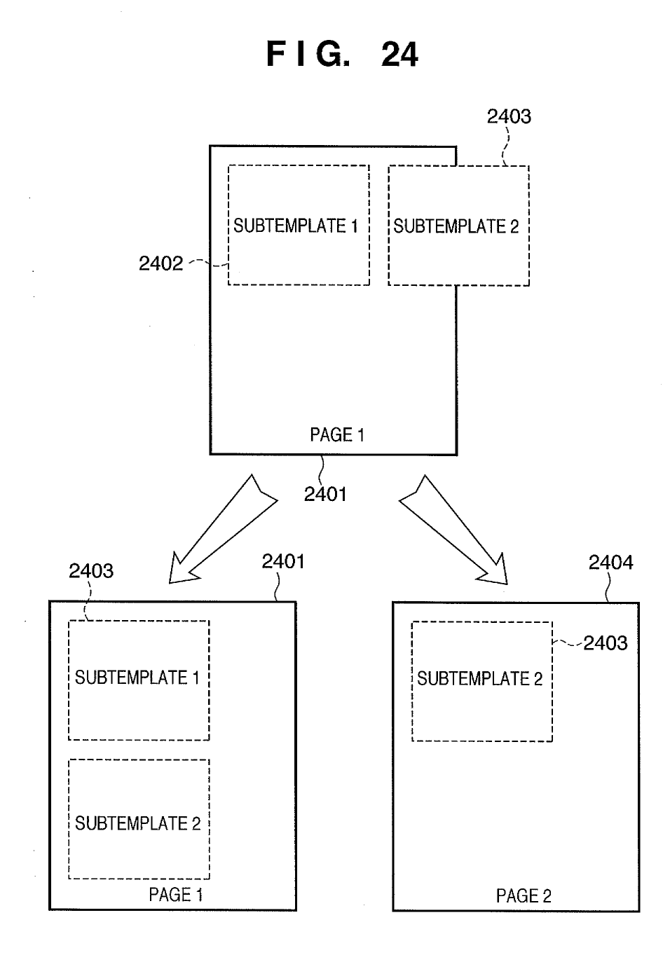

A concrete example of wraparound processing in step S1714 of FIG. 17B will be explained with reference to FIG. 24.

FIG. 24 is a view for explaining wraparound processing for a subtemplate in a flow area according to the first embodiment of the present invention.

As described above, when the subtemplate size is larger than the flow area size and redefinition of the layout structure of the subtemplate is inhibited, wraparound processing is done for the subtemplate in the flow area.

In this example, a subtemplate 2403 cannot be arranged adjacent to a subtemplate 2402 in a document 2401. In this case, two types of wraparound processes are tried to move the subtemplate to a free space in the document 2401.

When a free space larger than the size of the subtemplate 2403 exists in the flow area of the document 2401 in which the subtemplate 2402 is arranged, the subtemplate 2403 is arranged in the free space.

When a free space in the flow area of the document 2401 in which the subtemplate 2402 is arranged is smaller than the size of the subtemplate 2403, a document 2404 is newly created. Then, the subtemplate 2403 is arranged in the flow area of the document 2404.

In the wraparound processing, based on the free space of the flow area, the target subtemplate is arranged in the free space or in a new flow area of a newly created document template.

A concrete case where the layout structure of a subtemplate cannot be redefined (redefinition fails) in step S2101 of FIG. 21 will be described with reference to FIG. 25.

FIG. 25 is a view for explaining a concrete case where the layout structure of a subtemplate cannot be redefined (redefinition fails) according to the first embodiment of the present invention.

As shown in FIG. 25, assume that a subtemplate 2504 is obtained as a result of redefining the layout structure of the subtemplate 2003 in the state of FIG. 20. The size of the subtemplate 2504 is larger than that of the flow area 2007. For this reason, the layout structure of the subtemplate 2504 cannot be redefined any more.

In this case, it is determined that the layout structure of the subtemplate 2003 in FIG. 20 cannot be redefined. The layout structure of the subtemplate 2504 in FIG. 25 returns to the subtemplate 2003 in FIG. 20. In this case, wraparound processing is executed in step S1714 to move the subtemplate to a position where the subtemplate can be arranged in the flow area.

An example of a user interface for setting flowing of a container into a subtemplate when redefining the layout structure will be described with reference to FIG. 26.

FIG. 26 is a view showing an example of a user interface for setting flowing of a container according to the first embodiment of the present invention.

A user interface 2601 allows setting, with prepared setting items (radio buttons), the arrangement (arrangement rule) of containers in the free space of a flow area in a document in a set wraparound direction.

In FIG. 26, a direction in which containers are flowed into a subtemplate is set by selecting one of radio buttons 2602 to 2606.

The radio button 2602 is used to arrange containers in a flow area in the vertical direction from the top to bottom using the upper end of a subtemplate as a starting point.

The radio button 2603 is used to arrange containers in a subtemplate in the horizontal direction from the left to right using the upper left end of the subtemplate as a starting point, and when no more container can be arranged in the horizontal direction, changing the container arrangement position to a lower row, and arranging containers again in the horizontal direction from the left to right.

The radio button 2604 is used to arrange containers in a subtemplate in the vertical direction from the top to bottom using the upper left end of the subtemplate as a starting point, and when no more container can be arranged in the vertical direction, changing the container arrangement position to a right column, and arranging containers again in the vertical direction from the top to bottom.

The radio button 2605 is used to arrange containers in a subtemplate in the horizontal direction from the right to left using the upper right end of the subtemplate as a starting point, and when no more container can be arranged in the horizontal direction, changing the container arrangement position to a lower row, and arranging containers again in the horizontal direction from the right to left.

The radio button 2606 is used to arrange containers in a subtemplate in the vertical direction from the top to bottom using the upper right end of the subtemplate as a starting point, and when no more container can be arranged in the vertical direction, changing the container arrangement position to a left column, and arranging containers again in the vertical direction from the top to bottom.

If the user presses an OK button 2607, the container wraparound setting made via the user interface 2601 is stored as wraparound setting information in the memory 136. If the user presses a cancel button 2608, the wraparound setting made via the user interface 2601 is canceled, and the user interface 2601 disappears.

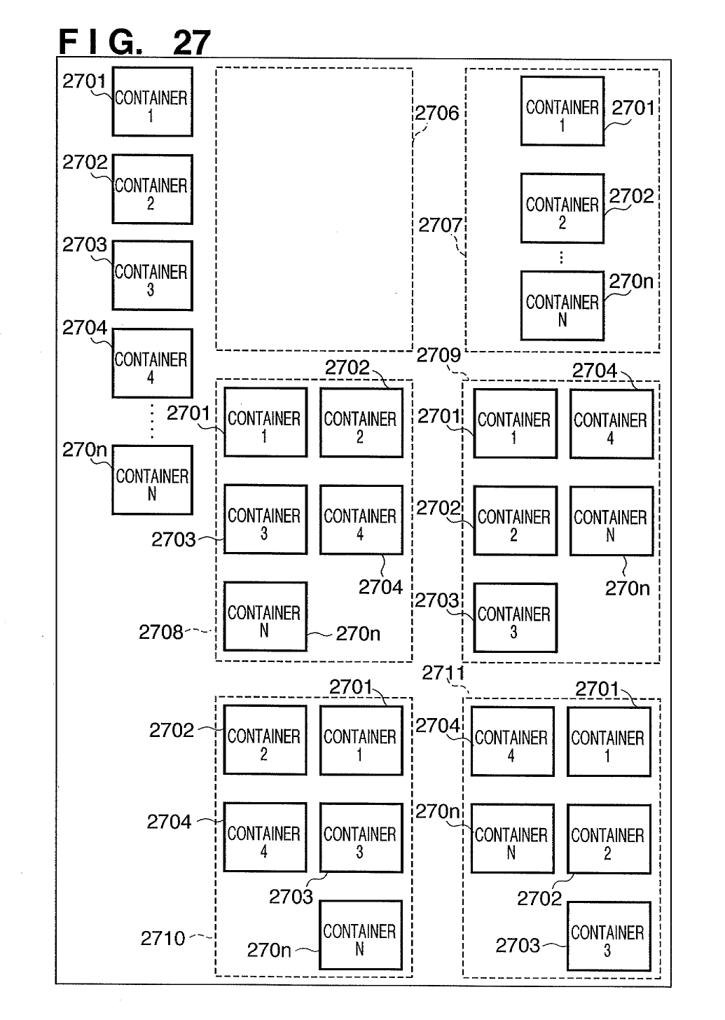

An example of flowing a container into a subtemplate in accordance with wraparound setting information set via the user interface 2601 will be described with reference to FIG. 27.

FIG. 27 is a view showing an example of flowing a container into a subtemplate according to the first embodiment of the present invention.

In the description of FIG. 27, subtemplates are also flowed into a flow area by the same setting and behavior as those of flowing containers into a subtemplate. The setting and behavior can be implemented via a user interface for a flow area that is identical to the user interface 2601 in FIG. 26.

In FIG. 27, one to N (N is an integer) containers 2701 to 270n (containers 1 to N) are arranged by flowing them into a subtemplate 2706 in accordance with wraparound setting information set via the user interface 2601.

A subtemplate 2707 represents a flowing example when the user selects the radio button 2602 in the user interface 2601. In this case, the containers 2701, 2702, . . . , and 270n are arranged sequentially in the vertical direction from the top.

A subtemplate 2708 represents a flowing example when the user selects the radio button 2603 in the user interface 2601. In this case, the containers 2701 and 2702 are arranged in the horizontal direction from the left to right using the upper left end of the subtemplate 2708 as a starting point. Since the container 2703 cannot be arranged in the horizontal direction, it is flowed down in the subtemplate 2708 and arranged again using the left end as a starting point. The containers 2704 and 270n are also arranged by the same procedures.

A subtemplate 2709 represents a flowing example when the user selects the radio button 2604 in the user interface 2601. In this case, the containers 2701, 2702, and 2703 are arranged in the vertical direction from the top to bottom using the upper left end of the subtemplate 2709 as a starting point. Since the container 2704 cannot be arranged in the vertical direction, it is flowed right in the subtemplate 2709 and arranged again using the left end as a starting point. The container 2705 is also arranged by the same procedures.

A subtemplate 2710 represents a flowing example when the user selects the radio button 2605 in the user interface 2601. The containers 2701 and 2702 are arranged in the horizontal direction from the right to left using the upper right end of the subtemplate 2710 as a starting point. Since the container 2703 cannot be arranged in the horizontal direction, it is flowed down in the subtemplate 2710 and arranged again using the right end as a starting point. The containers 2704 and 270n are also arranged by the same procedures.

A subtemplate 2711 represents a flowing example when the user selects the radio button 2606 in the user interface 2601. The containers 2701, 2702, and 2703 are arranged in the vertical direction from the top to bottom using the upper right end of the subtemplate 2711 as a starting point. Since the container 2704 cannot be arranged in the vertical direction, it is flowed left in the subtemplate 2711 and arranged again using the right end as a starting point. The container 2705 is also arranged by the same procedures.

An example of a user interface for setting redefinition of the layout structure of a subtemplate in a flow area, and setting a margin when arranging a container will be explained with reference to FIG. 28. Setting information made via this user interface is used for determination in step S1711 of FIG. 17B.

FIG. 28 is a view showing an example of a user interface for setting redefinition of the layout structure of a subtemplate, and setting a margin when arranging a container according to the first embodiment of the present invention.

A user interface 2801 allows setting, with prepared setting items (radio buttons, check box, and the like), redefinition of the layout structure of a subtemplate, and a margin when arranging a container.

Radio buttons 2802 and 2803 are used to set whether to redefine the layout structure of a subtemplate in a flow area. Based on the setting information, it is determined in step S1711 whether to redefine the layout structure of a subtemplate or execute conventional wraparound processing in a flow area.

A check box 2804 becomes valid only when the user selects the radio button 2803. The check box 2804 allows canceling a link between containers set in a subtemplate, and setting whether to set a margin around a rearranged container.

When the user selects the check box 2804, he determines upper, lower, right, and left margins in text boxes 2805. The upper, lower, right, and left margins correspond to the top, bottom, right, and left (top, bottom, right, and left sides) of a document.

If the user presses an OK button 2806, the settings (layout structure redefinition setting and margin setting when arranging a container) made via the user interface 2801 are stored as setting information in the memory 136. If the user presses a cancel button 2807, the settings made via the user interface 2801 are canceled, and the user interface 2801 disappears.

As described above, according to the first embodiment, a document with a layout reflecting the user intention as much as possible can be created by readjusting the layout structure of a subtemplate to a size matching a flow area. An optimum layout can be provided without preparing a plurality of subtemplates in order to reflect the user intention.

### Second Embodiment

By the processes shown in FIGS. 17B and 21 according to the first embodiment, the layout structure of a subtemplate is temporarily redefined to adjust the size of the subtemplate in accordance with that of a flow area where the subtemplate is to be arranged.

In the first embodiment, all elements such as containers and links which constitute a subtemplate arranged in a flow area designated via the user interfaces shown in FIGS. 26 and 28 are redefined. However, redefined containers and links which constitute a subtemplate may not meet the user intention.

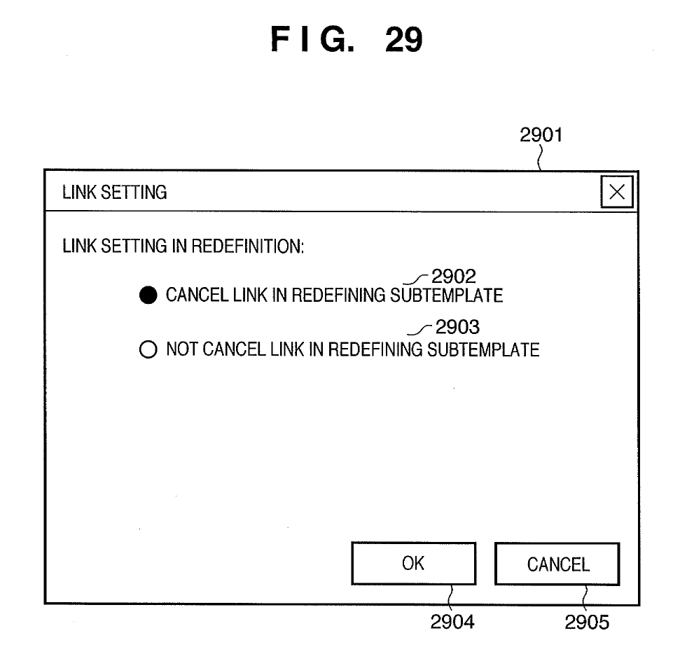

The second embodiment will describe a configuration for controlling the behavior in redefinition using a user interface shown in FIG. 29 via a link which constitutes a subtemplate. The second embodiment provides a user interface for making a link setting in redefinition.

FIG. 29 is a view showing an example of a user interface for making a link setting according to the second embodiment of the present invention.

FIG. 29 shows an example of a user interface for setting whether to permit cancellation of a link which constitutes a layout structure defined for a subtemplate when temporarily redefining the layout structure. A user interface 2901 allows setting, with prepared setting items (radio buttons), whether to permit cancellation of a link which constitutes a layout structure defined for a subtemplate when temporarily redefining the layout structure.

Radio buttons 2902 and 2903 are used to set, in redefinition, cancellation of a link which is defined in a subtemplate and is connected to a container to be redefined. This setting can be made for each link defined in a subtemplate.

The radio button 2902 is used to permit cancellation of a set link when the link is connected to a container to be redefined in redefining a subtemplate.

The radio button 2903 is used to inhibit cancellation of a set link when the link is connected to a container to be redefined in redefining a subtemplate.

If the user presses an OK button 2904, the link setting made via the user interface 2901 is stored as setting information in a memory 136. If the user presses a cancel button 2905, the link setting made via the user interface 2901 is canceled, and the user interface 2901 disappears.

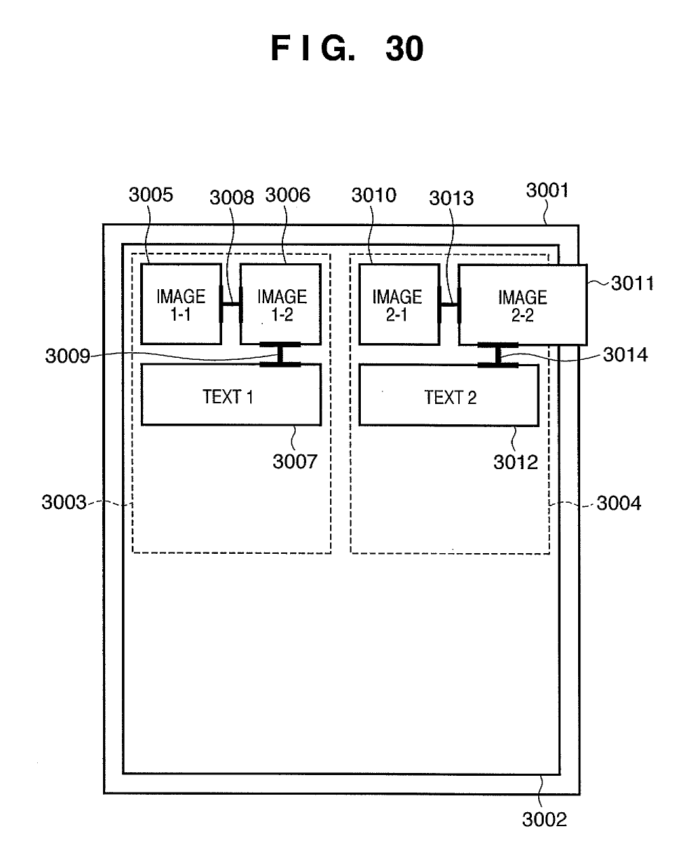

An arrangement of a subtemplate on the basis of the link setting using the user interface 2901 in FIG. 29 will be explained with reference to FIG. 30.

FIG. 30 is a view showing an arrangement of a subtemplate according to the second embodiment of the present invention.

In FIG. 30, subtemplates 3003 and 3004 for which link settings are made via the user interface 2901 in FIG. 29 are arranged in a flow area 3002 of a document 3001.

In the subtemplate 3003, image containers 3005 and 3006 and a text container 3007 are laid out. The image containers 3005 and 3006 are linked to each other via a link 3008. The image container 3006 and text container 3007 are linked to each other via a link 3009.

In the subtemplate 3004, image containers 3010 and 3011 and a text container 3012 are laid out. The image containers 3010 and 3011 are linked to each other via a link 3013. The image container 3011 and text container 3012 are linked to each other via a link 3014.

Assume that it is set for the links 3008 and 3013 with the radio button 2902 of the user interface 2901 in FIG. 29 to permit cancellation of a link in redefinition. Also assume that it is set for the links 3009 and 3014 with the radio button 2903 of the user interface 2901 in FIG. 29 to inhibit cancellation of a link in redefinition.

The setting of the link 3009 reflects the user intention to always arrange the text container 3007 below the image container 3006. The setting of the link 3014 reflects the user intention to always arrange the text container 3012 below the image container 3011.

In the subtemplate 3004, the image container 3011 exceeds the flow area 3002 upon inserting contents. At this time, if a radio button 2803 (redefinition setting) of a user interface 2801 in FIG. 28 is selected, the subtemplate 3004 is redefined for the image container 3011 in step S1712.

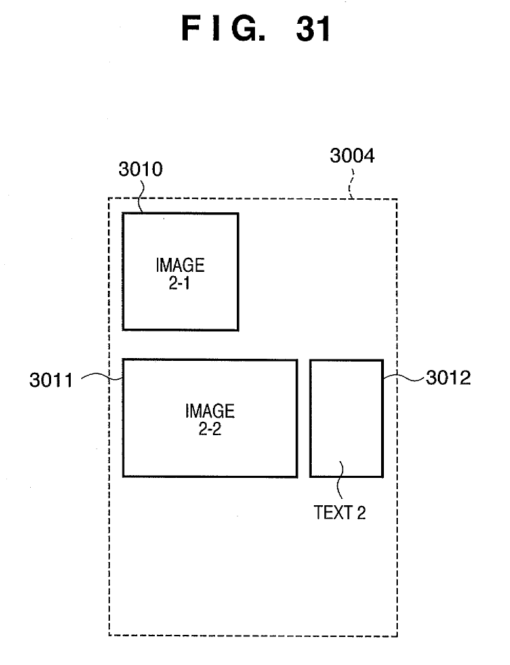

When redefining the subtemplate 3004 in FIG. 30 according to the configuration of the first embodiment, the image container 3011 to be redefined in the subtemplate 3004 is rearranged. In this case, the links 3013 and 3014 in the subtemplate 3004 are canceled, and the subtemplate 3004 changes to an arrangement as shown in FIG. 31.

In contrast, according to the configuration of the second embodiment, the subtemplate is redefined based on the presence/absence of the link cancellation setting.

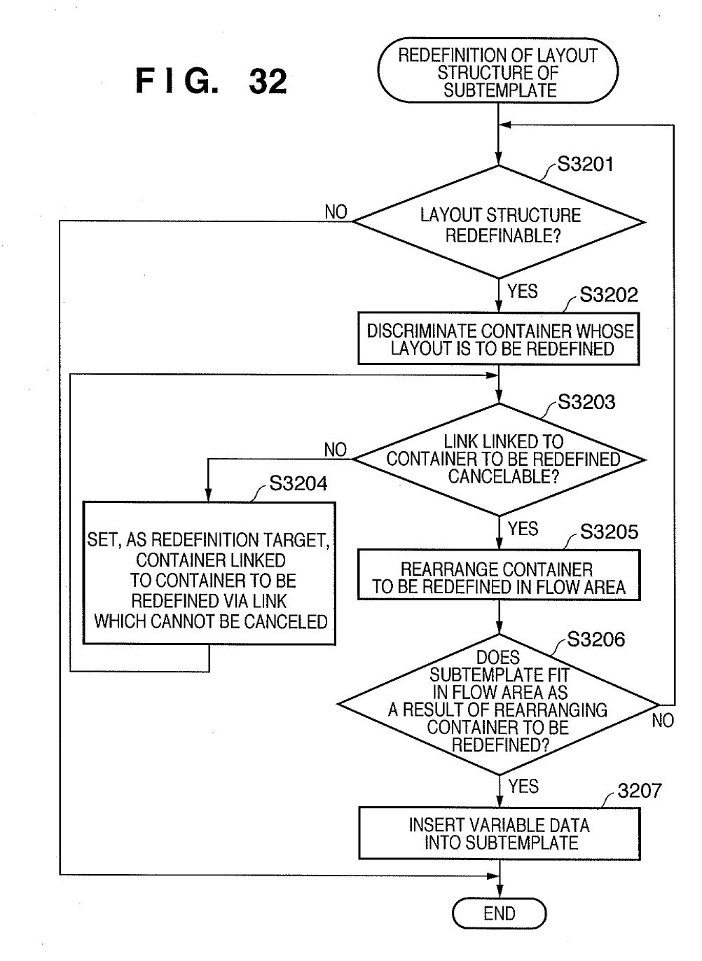

Redefinition processing for the layout structure of a subtemplate according to the second embodiment will be explained with reference to FIG. 32.

FIG. 32 is a flowchart showing redefinition processing for the layout structure of a subtemplate according to the second embodiment of the present invention.

The flowchart in FIG. 32 basically complies with that in FIG. 21 according to the first embodiment.

In step S3201, a layout editing application 121 determines whether the layout structure of a subtemplate can be redefined. This determination method is the same as that in step S2101 of FIG. 21.

If the layout structure of the subtemplate can be redefined (YES in step S3201), the process proceeds to step S3202. If the layout structure of the subtemplate cannot be redefined (NO in step S3201), the layout editing application 121 returns the layout structure of the subtemplate to one before redefinition, and the process ends.

In step S3202, the layout editing application 121 discriminates a container whose layout is to be redefined.

In the example of FIG. 30, the layout editing application 121 discriminates, based on the layout structure of the subtemplate 3004, a container which makes the size of the subtemplate 3004 exceed the size (width) of the flow area 3002. In this case, the width of the subtemplate 3004 exceeds that of the flow area 3002 owing to the image container 3011. Thus, the layout editing application 121 discriminates the image container 3011 as a container to be redefined.

In the second embodiment, after discriminating a container for which the layout structure of the subtemplate is to be redefined, the layout editing application 121 newly executes step S3203. More specifically, in step S3203, the layout editing application 121 determines whether a link linked to the container to be redefined can be canceled. This determination is based on setting information made via the user interface 2901 in FIG. 29.

If no link can be canceled (NO in step S3203), the process proceeds to step S3204. If the link can be canceled (YES in step S3203), the process proceeds to step S3205.

If the link can be canceled, processes in steps S3205 to S3207 are executed. These processes correspond to steps S2104 to S2106 in FIG. 21, and a detailed description thereof will not be repeated.

If no link can be canceled, the layout editing application 121 discriminates again a container to be redefined in step S3204.

A concrete example will be explained with reference to FIG. 30.

The image container 3011 is linked to the image container 3010 via the link 3013. The image container 3011 is linked to the text container 3012 via the link 3014.

It is set for the link 3013 with the radio button 2902 (FIG. 29) to permit cancellation of a link, so the link 3013 to the image container 3011 is canceled. It is set for the link 3014 with the radio button 2903 (FIG. 29) to inhibit cancellation of a link, so the link 3014 to the image container 3011 is not canceled.

For this reason, in step S3204, the layout editing application 121 widens the layout redefinition target to the text container 3012 linked to the image container 3011 via the link 3014, and executes subtemplate redefinition processing.

After this processing, the layout editing application 121 makes determination in step S3203, and arranges the text container 3012 linked to the image container 3011 via the link 3014 in the flow area 3002 in step S3205.

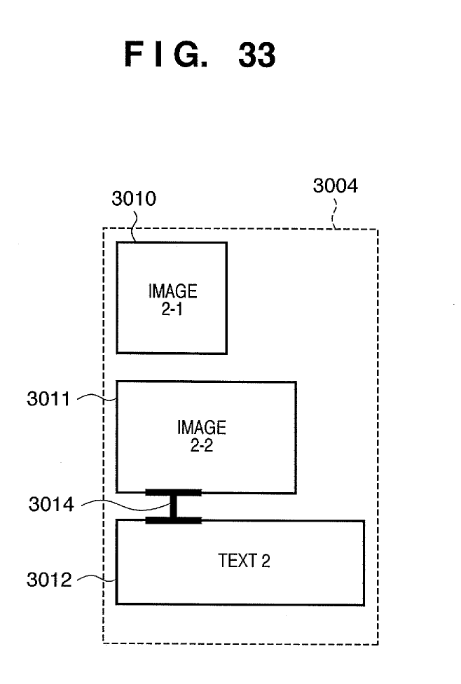

In this case, an arrangement as shown in FIG. 33 is obtained. As shown in FIG. 33, a layout structure is newly defined, in which the image container 3011 and text container 3012 are flowed within the subtemplate 3004 without canceling the link 3014 between them.

As described above, according to the second embodiment, in addition to the effects described in the first embodiment, the layout structure of a subtemplate can be redefined according to the user intention in consideration of whether cancellation of a link is permitted/inhibited. Hence, a document with a layout the user wants can be created.

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or script data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-346654 filed on Dec. 22, 2006, which is hereby incorporated by reference herein in its entirety.

What is claimed is:

1. An information processing apparatus which lays out, in a document, a template prepared by arranging a field area for inserting data of a data field selected from a record including a plurality of types of data fields, the apparatus comprising:
layout means for executing layout processing for the template by inserting the template into a flow area set in the document;
acquisition means for acquiring a size of the template when data is inserted into the field area in the template inserted in the flow area;
first determination means for determining whether or not the template can be arranged in the flow area by using the size of the template and size of an empty area of the flow area; and
definition means for redefining a positional relation of the template when said first determination means determined that the template cannot be arranged in the flow area.

2. The apparatus according to claim 1, wherein said definition means changes, in the template, position of the data field which cannot be arranged in the flow area.

3. The apparatus according to claim 1, further comprising deformation means for deforming a shape of the template to make the shape of the template conform to a shape of the flow area after changing the positional relation of the field area by said definition means.

4. The apparatus according to claim 1, further comprising setting means for making a setting for redefinition of the template.

5. The apparatus according to claim 4, wherein said setting means has a first setting item for setting whether to permit/inhibit redefinition of the template, and a second setting item for setting a margin of a field area to be rearranged when the redefinition is permitted.

6. The apparatus according to claim 4, wherein said definition means comprises
second determination means for determining, based on setting information of said setting means, whether to redefine the template,
discrimination means for discriminating a field area whose arrangement is to be redefined, on the basis of a size of a field area after inserting data into the field area, in order to change the positional relation of the field area arranged in the template when said second determination means determines to redefine the positional relation of the template, and
change means for changing the layout structure of the field area arranged in the template by changing the arrangement of the field area to be redefined that is discriminated by said discrimination means.

7. The apparatus according to claim 6, wherein when a link for linking a second field area to a first field area discriminated to be redefined is set, said discrimination means discriminates even the second field area as a field area to be redefined.

8. The apparatus according to claim 7, further comprising link setting means for setting whether to permit/inhibit cancellation of the link when said definition means redefines the template.

9. The apparatus according to claim 6, further comprising designation means for, when said second determination means determines not to redefine the template, designating an arrangement rule to change a layout structure of the field area arranged in the template without redefining the template.

10. A method of controlling an information processing apparatus which lays out, in a document, a template prepared by arranging a field area for inserting data of a data field selected from a record including a plurality of types of data fields, the method comprising:
a layout step of causing layout means to execute layout processing for the template by inserting the template into a flow area set in the document;
an acquisition step of causing acquisition means to acquire a size of the template when data is inserted into the field area in the template inserted in the flow area;
a determination step of causing determination means to determine whether or not the template can be arranged in the flow area by using the size of the template and size of an empty area of the flow area, and
a definition step of causing definition means to redefine a positional relation of the template when said determination step determined that the template cannot be arranged in the flow area.

11. A computer program which is stored in a computer-readable medium and causes a computer to execute control of an information processing apparatus that lays out, in a document, a template prepared by arranging a field area for inserting data of a data field selected from a record including a plurality of types of data fields, the program causing the computer to execute
a layout step of executing layout processing for the template by inserting the template into a flow area set in the document,
an acquisition step of acquiring a size of the template when data is inserted into the field area in the template inserted in the flow area,
a determination step of causing determination means to determine whether or not the template can be arranged in the flow area by using the size of the template and size of an empty area of the flow area, and a defintion step of causing definition means to redefine a positional relation of the template when said determination step determined that the template cannot be arranged in the flow area.
